(19) United States
(12) Patent Application Publication
(10) Pub. No.: US 2020/0005118 A1
(43) Pub. Date: Jan. 2, 2020

(54) OFFTRACK VIRTUAL AGENT INTERACTION SESSION DETECTION

(71) Applicant: Microsoft Technology Licensing, LLC, Redmond, WA (US)

(72) Inventors: Zhirong Chen, Sammamish, WA (US); Junyan Chen, Bellevue, WA (US); Xin Wan, Redmond, WA (US); Volodymyr Trubachov, Redmond, WA (US); Huicheng Song, Bellevue, WA (US); Yanfen Song, Redmond, WA (US); Jiayuan Huang, Bellevue, WA (US); Jiantao Sun, Bellevue, WA (US); Shichao Hu, Bellevue, WA (US); Zheng Chen, Bellevue, WA (US)

(21) Appl. No.: 16/022,336

(22) Filed: Jun. 28, 2018

(51) Int. Cl. G06N 3/00; G06F 17/27; G06N 3/04; G06N 3/08

(52) U.S. Cl. CPC G06N 3/006; G06F 17/2785; G06F 3/0481; G06N 3/084; G06N 3/0445

(57) ABSTRACT

Generally discussed herein are devices, systems, and methods for detecting a conversation with a virtual agent is offtrack and responding appropriately. A method can include receiving a prompt, expected responses to the prompt, and a response of an interaction session with the virtual agent, the interaction session to solve a problem of a user, determining whether the response indicates the interaction session is in an offtrack state based on the prompt, expected responses, and response, in response to a determination that the interaction session is in the offtrack state, determining a taxonomy of the offtrack state, and providing, based on the determined taxonomy, a next prompt to the interaction session.

### RELATED APPLICATIONS

This application is related to U.S. patent application Ser. No. ______ titled “ARTIFICIAL INTELLIGENCE ASSISTED CONTENT AUTHORING FOR AUTOMATED AGENTS” and filed on Jun. _, 2018, U.S. patent application Ser. No. ______ titled “KNOWLEDGE-DRIVEN DIALOG SUPPORT CONVERSATION SYSTEM” and filed on Jun. _, 2018, U.S. patent application Ser. No. ______ titled “CONTEXT-AWARE OPTION SELECTION IN VIRTUAL AGENT” and filed on Jun. _, 2018, and U.S. patent application Ser. No. ______ titled “VISUALIZATION OF USER INTENT IN VIRTUAL AGENT INTERACTION” and filed on Jun. _, 2018, the contents of each of which is incorporated herein by reference in their entirety.

### BACKGROUND

Virtual agents are becoming more prevalent for a variety of purposes. A virtual agent may conduct a conversation with a user. The conversation with the user may have a purpose, such as to provide a user with a solution to a problem they are experiencing. Current virtual agents fail to meet user expectations or solve the problem when they receive a response from the user that is unexpected. Typically, the virtual agent includes a set of predefined answers that it expects, based on use of a set of predefined questions, often in a scripted dialogue. An unexpected response is anything that is not in the predefined answers. The virtual agents are not equipped to respond to the unexpected response in a manner that is satisfactory to the user. Typically, the virtual agent ignores the unexpected user response, and simply repeats the previous question. These virtual agents are very linear in their approach to problem solving and do not allow any variation from the linear “if then” structures that scope the problem and solutions. This leads to user frustration with the virtual agent or a brand or company associated with the virtual agent, or lack of resolution to the problem.

### SUMMARY

This summary section is provided to introduce aspects of embodiments in a simplified form, with further explanation of the embodiments following in the detailed description. This summary section is not intended to identify essential or required features of the claimed subject matter, and the combination and order of elements listed in this summary section are not intended to provide limitation to the elements of the claimed subject matter.

Embodiments described herein generally relate to virtual agents that provide enhanced user flexibility in responding to a user in an offtrack conversation. Embodiments regard detecting when the conversation is offtrack and responding appropriately. In particular, the following techniques use artificial intelligence and other technological implementations for the determination of whether a user, by a response, intended to select an expected answer without providing or selecting the expected answer verbatim. In an example, embodiments may include a virtual agent interface device to provide an interaction session in a user interface with a human user, the interaction session regarding a problem to be solved by a user, processing circuitry in operation with the virtual agent interface device to receive a prompt, expected responses to the prompt, and a response of the interaction session, determine whether the response indicates the interaction session is in an offtrack state based on the prompt, expected responses, and response, in response to a determination that the interaction session is in the offtrack state, determine a taxonomy of the offtrack state, and provide, based on the determined taxonomy, a next prompt to the interaction session.

An embodiment discussed herein includes a computing device including processing hardware (e.g., a processor) and memory hardware (e.g., a storage device or volatile memory) including instructions embodied thereon, such that the instructions, which when executed by the processing hardware, cause the computing device to implement, perform, or coordinate the electronic operations. Another embodiment discussed herein includes a computer program product, such as may be embodied by a machine-readable medium or other storage device, which provides the instructions to implement, perform, or coordinate the electronic operations. Another embodiment discussed herein includes a method operable on processing hardware of the computing device, to implement, perform, or coordinate the electronic operations.

As discussed herein, the logic, commands, or instructions that implement aspects of the electronic operations described above, may be performed at a client computing system, a server computing system, or a distributed or networked system (and systems), including any number of form factors for the system such as desktop or notebook personal computers, mobile devices such as tablets, netbooks, and smartphones, client terminals, virtualized and server-hosted machine instances, and the like. Another embodiment discussed herein includes the incorporation of the techniques discussed herein into other forms, including into other forms of programmed logic, hardware configurations, or specialized components or modules, including an apparatus with respective means to perform the functions of such techniques. The respective algorithms used to implement the functions of such techniques may include a sequence of some or all of the electronic operations described above, or other aspects depicted in the accompanying drawings and detailed description below.

This summary section is provided to introduce aspects of the inventive subject matter in a simplified form, with further explanation of the inventive subject matter following in the text of the detailed description. This summary section is not intended to identify essential or required features of the claimed subject matter, and the particular combination and order of elements listed this summary section is not intended to provide limitation to the elements of the claimed subject matter.

### BRIEF DESCRIPTION OF DRAWINGS

FIG. 1 illustrates, by way of example, a flow diagram of an embodiment of an interaction session (e.g., a conversation) between a virtual agent and a user.

FIG. 2 illustrates, by way of example, a diagram of an embodiment of a method performed by a conventional virtual agent.

FIG. 3 illustrates, by way of example, a diagram of an embodiment of a method for smart match determination and selection.

FIG. 4 illustrates, by way of example, a diagram of an embodiment of a method for handling the five failure taxonomies discussed with regard to FIG. 3.

FIG. 5 illustrates, by way of example, a diagram of an embodiment of a method of performing an operation of FIG. 4.

FIG. 6 illustrates, by way of example, a block flow diagram of an embodiment of the model match operation of FIG. 4 for semantic matching.

FIG. 7 illustrates, by way of example, a block flow diagram of an embodiment of the highway ensemble processor.

FIG. 8 illustrates, by way of example, a block flow diagram of an embodiment of an RNN.

FIG. 9 illustrates, by way of example, a diagram of an embodiment of a system for offtrack detection and response.

FIG. 10 illustrates, by way of example, a diagram of an embodiment of a method for handling an offtrack conversation.

FIG. 11 illustrates, by way of example, a diagram of another embodiment of a method for handling an offtrack conversation.

FIG. 12 illustrates, by way of example, a diagram of an embodiment of an example system architecture for enhanced conversation capabilities in a virtual agent.

FIG. 13 illustrates, by way of example, a diagram of an embodiment of an operational flow diagram illustrating an example deployment of a knowledge set used in a virtual agent, such as with use of the conversation model and online/offline processing depicted in FIG. 12.

FIG. 14 illustrates, by way of example, a block diagram of an embodiment of a machine (e.g., a computer system) to implement one or more embodiments.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the embodiments. It is to be understood that other embodiments may be utilized and that structural, logical, and/or electrical changes may be made without departing from the scope of the embodiments. The following description of embodiments is, therefore, not to be taken in a limited sense, and the scope of the embodiments is defined by the appended claims.

The operations, functions, or algorithms described herein may be implemented in software in some embodiments. The software may include computer executable instructions stored on computer or other machine-readable media or storage device, such as one or more non-transitory memories (e.g., a non-transitory machine-readable medium) or other type of hardware based storage devices, either local or networked. Further, such functions may correspond to subsystems, which may be software, hardware, firmware or a combination thereof. Multiple functions may be performed in one or more subsystems as desired, and the embodiments described are merely examples. The software may be executed on a digital signal processor, ASIC, microprocessor, central processing unit (CPU), graphics processing unit (GPU), field programmable gate array (FPGA), or other type of processor operating on a computer system, such as a personal computer, server or other computer system, turning such computer system into a specifically programmed machine. The functions or algorithms may be implemented using processing circuitry, such as may include electric and/or electronic components (e.g., one or more transistors, resistors, capacitors, inductors, amplifiers, modulators, demodulators, antennas, radios, regulators, diodes, oscillators, multiplexers, logic gates, buffers, caches, memories, GPUs, CPUs, field programmable gate arrays (FPGAs), or the like).

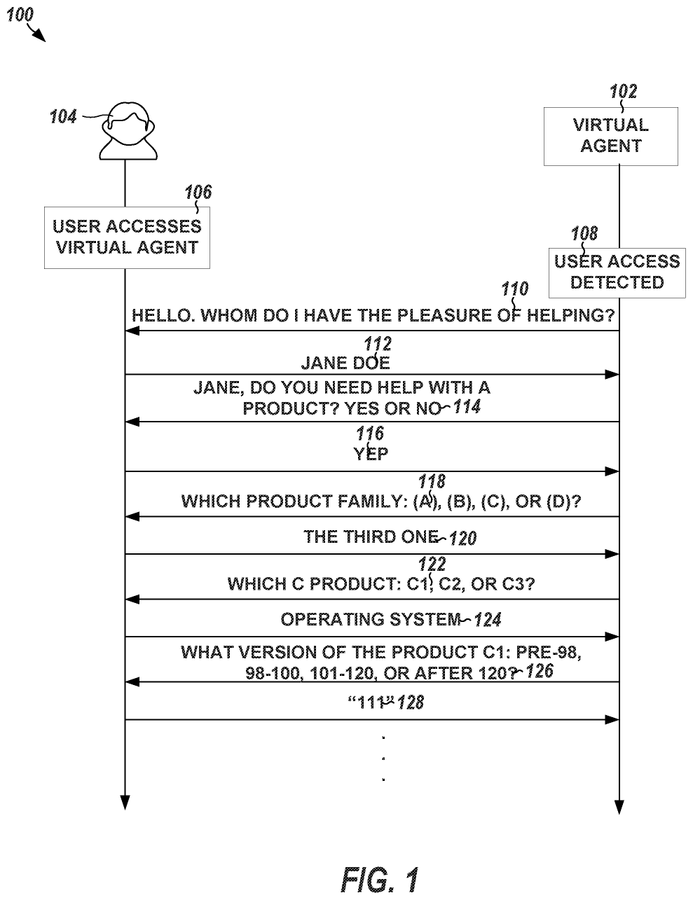

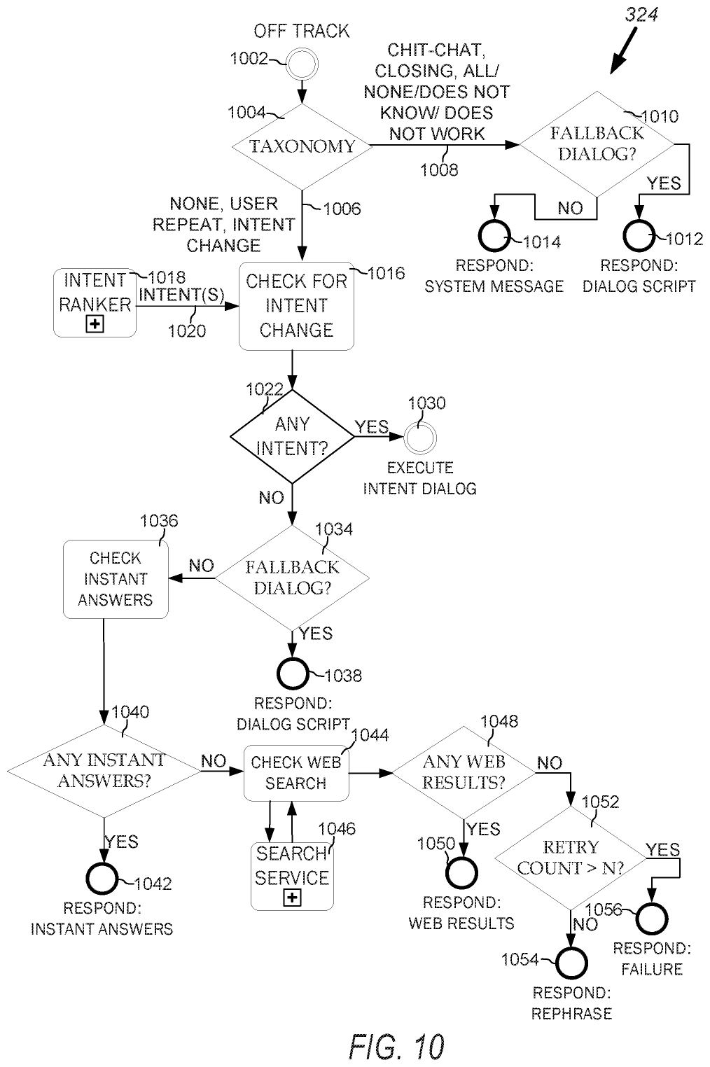

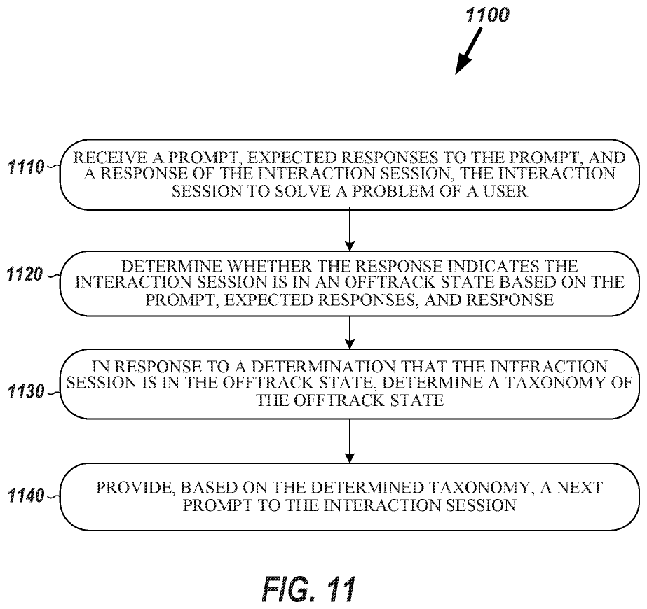

FIG. 1 illustrates, by way of example, a flow diagram of an embodiment of an interaction session (e.g., a conversation) between a virtual agent 102 and a user 104. The virtual agent 102 is a user-facing portion of an agent interaction system (see FIGS. 10 and 11). The agent interaction system receives user input and may respond to the user input in a manner that is similar to human conversation. The virtual agent 102 provides questions with selected answers to a user interface of the user 104. The user 104, through the user interface, receives the questions and expected answers from the virtual agent 102. The user 104 typically responds, through the user interface, to a prompt with a verbatim repetition of one of the choices provided by the virtual agent 102. The virtual agent 102 may be described in the following examples as taking on the form of a text-based chat bot, although other forms of virtual agents such as voice-based virtual assistants, graphical avatars, or the like, may also be used.

A conversation between the virtual agent 102 and the user 104 may be initiated through a user accessing a virtual agent webpage at operation 106. The virtual agent webpage may provide the user 104 with a platform that may be used to help solve a problem, hold a conversation to pass the time (“chit-chat”), or the like. The point or goal of the conversation, or whether the conversation has no point or goal, is not limiting.

At operation 108, the virtual agent 102 may detect the user 104 has accessed the virtual agent webpage at operation 106. The operation 106 may include the user 104 typing text in a conversation text box, selecting a control (e.g., on a touchscreen or through a mouse click or the like) that initiates the conversation, speaking a specified phrase into a microphone, or the like.

The virtual agent 102 may initiate the conversation or a pre-defined prompt may provide a primer for the conversation. In the embodiment illustrated, the virtual agent 102 begins the conversation by asking the user their name, at operation 110. The conversation continues with the user 104 providing their name, at operation 112. The virtual agent 102 then asks questions to merely illicit a user response or narrow down possible solutions to a user's problem. The questions provided by the virtual agent 102 may be consistent with a pre-defined “if-then” structure that defines “if the user responds with X, then ask question Y or provide solution Z”.

In the embodiment of FIG. 1, the virtual agent 102 narrows down the possible solutions to the user's problem by asking about a product family at operation 118, a specific product in the product family, at operation 122, and a product version, at operation 124. In the embodiment of FIG. 1, the user's responses at operations 120, 124, and 128 are responses that are not provided as one of the choices provided by the virtual agent 102. Each of the user's responses are examples of responses that are responsive and indicative of a choice, but are not exactly the choice provided. The operation 120 is an example of a user responding with an index of the choices provided. The operation 124 is an example of a user describing an entity corresponding to a choice provided. The operation 128 is an example of a user providing a response that is inclusive in a range of a choice provided.

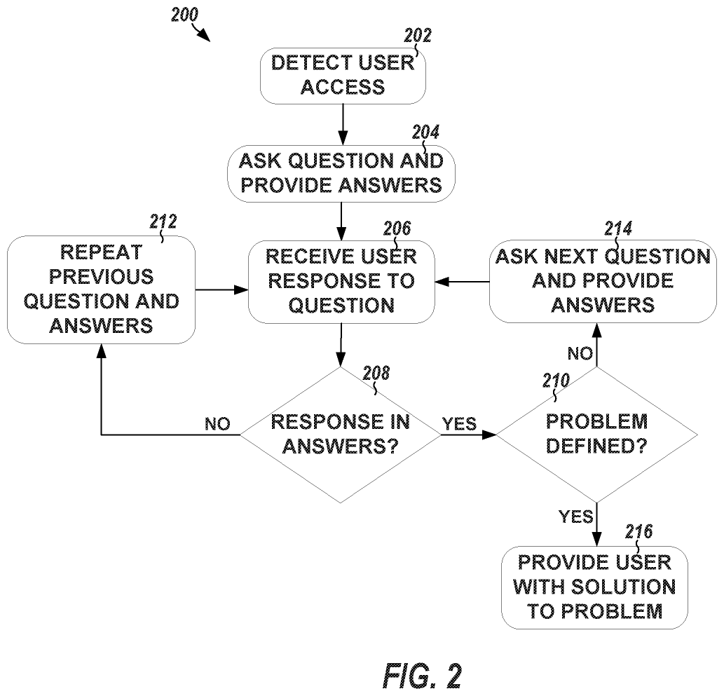

As discussed above, prior virtual agents provide a user with a prompt (e.g., question) and choices (options the user may select to respond to the prompt). In response, the virtual agent expects, verbatim, the user to respond with a given choice of the choices. For example, at operation 114, the virtual agent 102 asks the user 104 if they need help with a product and provides the choices “YES” and “NO”. A conventional virtual agent would not understand any choices outside of the provided choices “YES” and “NO” and thus would not understand the user's response of“YEP”, at operation 116. In such an instance, the bot would likely repeat the question or indicate to the user the “YEP” is not one of the choices and ask the user to select one of the choices provided. An example flow chart of operation of a typical prior chat bot is provided in FIG. 2 and described elsewhere herein.

Embodiments herein may provide a virtual agent that is capable of understanding and selecting a choice to which an unexpected user response corresponds. For example, the virtual agent 102 according to some embodiments may understand that responses like “YEP”, “YEAH”, “YAY”, “Y”, “SURE”, “AFFIRMATIVE”, or the like correspond to choice “YES”. The virtual agent 102 may select the choice “YES” in response to receiving such a response from the user 104. In another example, the virtual agent 102 according to some embodiments may understand that “THE THIRD ONE”, “THREE”, “TRES”, or the like, corresponds to an index choice of “C”. The virtual agent 102 may select the choice “C” in response to receiving such a response from the user 104. In yet another example, the virtual agent 102 in some embodiments may understand the phrase “OPERATING SYSTEM” or other word, phrase, or symbol describes the product “C1” and does not describe the products “C2” or “C3”. The virtual agent 102 may select the choice “C1” in response to receiving such a word, phrase, or symbol from the user 104. In yet another example, the virtual agent 102 in some embodiment may understand that “111” is a number within the range “101-120” and select that choice in response to receiving the response “111”, “ONE HUNDRED ELEVEN”, “ONE ONE ONE”, or the like.

The response of a user may or may not correspond to a choice provided by the virtual agent 102. A choice may be referred to as an entity. Entity understanding is important in a conversation system. Entity understanding may improve system performance from many perspectives (e.g., intent identification, slot filling, dialog strategy design, etc.). In embodiments of virtual agents discussed herein, techniques are used to extract most common types of entities, such as date, age, time, nationality, name, version, family, etc., among other entities. Entity reasoning logic may be customized to make the bot “smarter”, such as to understand and respond appropriately to a user that provides an unexpected response. For example, for each of the questions provided in FIG. 1, the virtual agent may infer the choice that the user 104 intended to select and select that choice. The virtual agent may then proceed in the conversation in accord with the predefined “if-then” structure towards a solution to the user's problem.

FIG. 2 illustrates, by way of example, a diagram of an embodiment of a method 200 performed by a conventional virtual agent. The method 200 begins with detecting a user access to a virtual agent, at operation 202. At operation 204, the virtual agent provides a question and a set of acceptable answers (choices) to the user. The virtual agent receives the user response to the question, at operation 206. At operation 208, the virtual agent determines whether the response provided by the user is, verbatim, one of the answers provided by the virtual agent. If the virtual agent determines, at operation 208, that the response matches, exactly, one of the answers, the virtual agent may determine whether the problem is defined to the point where the virtual agent may suggest a solution, at operation 210. If the virtual agent determines, at operation 212, that the response is not in the answers, the virtual agent repeats the previous question and answers and the method 200 continues at operation 206. If the virtual agent determines, at operation 210, that the problem is not defined to the point where the virtual agent may suggest a solution, the virtual agent asks the net pre-defined question based on the pre-defined dialog (the “if-then” dialog structure), at operation 214. If the virtual agent determines, at operation 210, that the problem is defined to the point where the virtual agent may suggest a solution, the virtual agent provides the user with the solution to the problem, at operation 216.

It is a common practice that a conversational virtual agent asks a question and provides several acceptable answers. It is also common that the virtual agent expects the user to select one acceptable answer verbatim. A virtual agent operating in accord with the method 200 is an example of such a virtual agent. Most virtual agents, such as those that operate in accord with FIG. 2, work well when the user follows system guidance in a strict way (e.g., selecting one of the options, such as by clicking, touching, speaking the choice verbatim or typing the choice verbatim). However, when the user types using natural language that does not match an answer exactly, prior virtual agents, like those that operate in accord with the method 200, fail to understand which choice the user desires to select. A virtual agent that operates in accord with the method of FIG. 2 merely repeats the previous question and options if the response from the user is not one of the answers (as determined at operation 208).

Virtual agents that operate in accord with FIG. 2 not only decrease task success rate, but also yield poor user experience and cause unnecessary user frustration. A user generally expects a virtual agent to operate as a human would. The user may provide a response that is only slightly different than a provided choice, and expect the virtual agent to understand. In the virtual agent that operates in accord with FIG. 2, the virtual agent repeats the question, frustrating the user who already provided an answer that would be acceptable to a human being.

A virtual agent, in accord with embodiments, may receive natural language text, analyze the natural language text, and determine to which provided answer, if any, the language text corresponds. Embodiments may leverage conversation context and built-in knowledge to do the answer matching. Besides exact string match between a user's response and the provided answers, embodiments may support more advanced matching mechanisms, such as model-based match, ordinal match, inclusive match, normalized query match, entity match with reasoning, etc. Embodiments may support entity identification and reasoning for matching, which makes the virtual agent “smart” relative to prior virtual agents. This makes the virtual agent more like a real human being than prior virtual agents.

A significant portion (more than five percent) of problem-solving virtual agent session failures are caused by a virtual agent's inability to understand a user's natural language response to option selection. Embodiments may help address this issue by providing an analysis hierarchy to solve most common natural language mismatches that cause the virtual agent to respond incorrectly or otherwise not correctly understand the user's response.

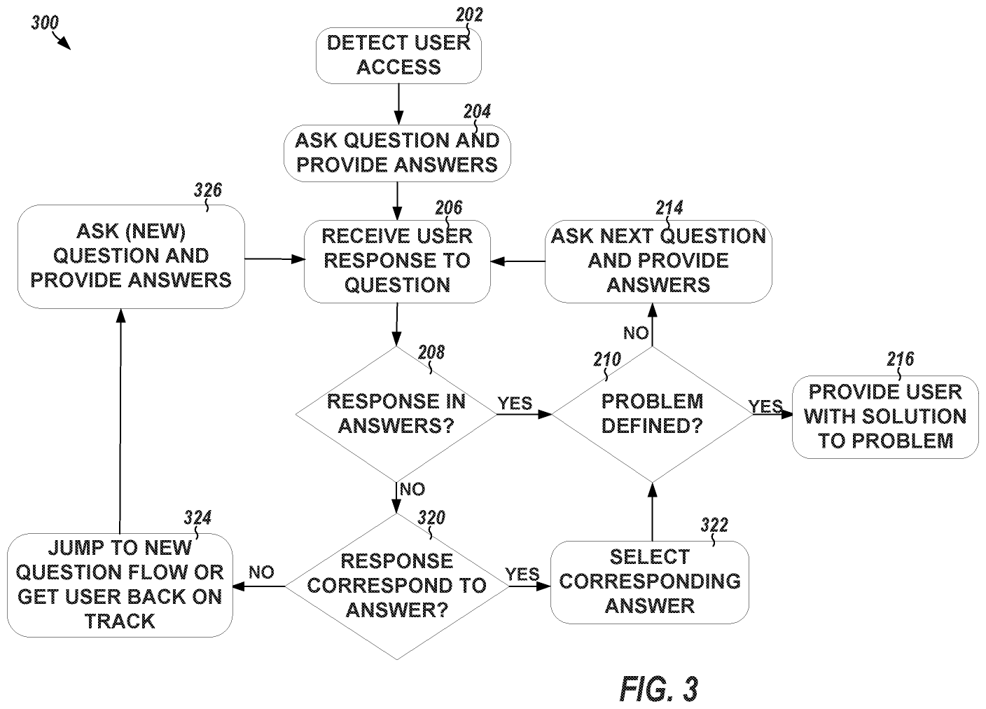

FIG. 3 illustrates, by way of example, a diagram of an embodiment of a method 300 for smart match determination and selection. The method 300 as illustrated includes operations 202, 204, 206, 208, 210, 214, and 216 of the method 200, described elsewhere herein. The method 300 diverges from the method 200 in response to determining, at operation 208, that the response provided at operation 206 is not in the answers provided at operation 204. Instead of repeating a question and answers, as in the method 200, the method 300 as illustrated includes, at operation 320, determining whether the answer provided by the user, at operation 206, corresponds to an answer provided (e.g., is not an exact match but the virtual agent may conclude with some degree of certainty that the user intended to select the answer). The operation 320 expands the number of possible answers that may be provided by the user to answer the question provided and thus improves the accuracy of the virtual agent and the user experience of using the virtual agent. More details regarding operation 320 are provided elsewhere herein.

In response to determining, at operation 320, that the response provided by the user corresponds to an answer (but is not an exact match of the answer), the corresponding answer may be selected at operation 322. Selecting the answer includes following the pre-defined dialog script to a next selection as if the user had selected the answer. After operation 322 the method 300 may continue at operation 210. In response to determining, at operation 320, that the response provided by the user does not correspond to an answer provided, the virtual agent may determine that the user is off-track and perform remediation operation 324. The remediation operation 324 may include jumping to a new work flow, a different point in the same work flow, or attempt to get the user back on track in the current work flow. In any of these cases, the virtual agent may ask the user a (new) question and provide answers or provide a non-question message to the user, at operation 326. After operation 326, the method 300 may continue at operation 206.

At operation 320, the virtual agent may determine, using one or more of a plurality of techniques, whether an unexpected user response (a response that is not included in a list of expected responses) corresponds to an answer provided at operation 204, 326, or 214. The techniques may include one or more of a variety of techniques: determining whether the response is a normalized match, determining whether the response is an ordinal match, determining whether the response is an inclusive match, determining whether the response is an entity match, or determining whether, based on a response model, the response is predicted to semantically match (have the same semantic meaning as) a provided answer.

Conventional implementations of virtual agents, as previously discussed, commonly determine only whether the response is an exact string match with a provided answer. Embodiments herein may do the same string comparison as the previous virtual agents, but also perform analysis of whether the response from the user was intended to select a provided answer, without requiring the provided answer verbatim. This may involve one of many applicable taxonomies of a user intending to select a provided answer without providing the answer verbatim. These taxonomies include: (1) semantic equivalence (e.g., user responds “Y” or “YEAH” to mean answer “YES”); (2) ordinal selection (e.g., user responds “THE FIRST ONE” to indicate the index of the answer to select); (3) an inclusive unique subset of one answer (e.g., answers include “OPERATING SYSTEM 8” and “OPERATING SYSTEM 9” and the user responds “9” to indicate “OPERATING SYSTEM 9” is to be selected); (4) a user provides a response that may be used to deduce the answer to select (e.g., in response to the question “HOW OLD ARE YOU?” with options “I AM BETWEEN 20 TO 70” and “I AM OLDER THAN 70” the user responds “I WAS BORN IN 1980”); and (5) typo (e.g., user misspells “INSTALL” as “INSTAL” or any other typographical error).

By allowing a user to provide a wider array of responses beyond the verbatim expected response, the user expectations regarding how the virtual agent should respond may be better matched. Research has shown that most (about 85% or more) of issues caused between a virtual agent and the user may be mitigated using one of the five techniques discussed. Solutions to each of the failure taxonomies are discussed in more detail below.

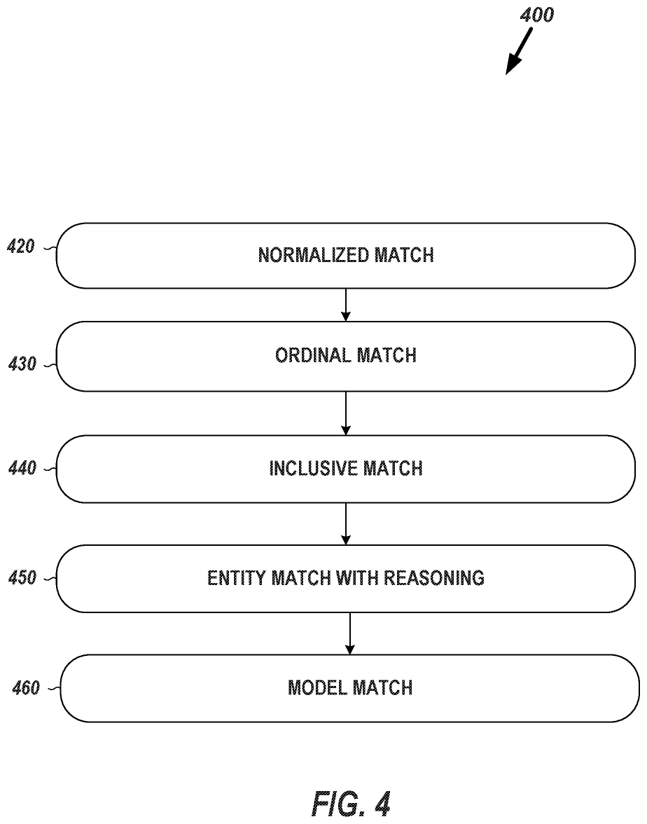

FIG. 4 illustrates, by way of example, a diagram of an embodiment of a method 400 for handling the five failure taxonomies discussed previously. The method 400 as illustrated includes determining if the response includes a normalized match, at operation 420; determining if the response includes an ordinal match, at operation 430; determining if the response includes an inclusive match, at operation 440; determining if the response includes an entity match, at operation 450; and determining if the response is a semantic match based on a model, at operation 460. Each of these operations is discussed in turn below. While the operations of the method 400 are illustrated in a particular order, the order of the operations is not limiting and the operations could be performed in a different order. In practice, the method 400 typically includes determining whether the response is an exact match of a provided answer before performing any of the operations illustrated in FIG. 4.

A normalized match, as identified in operation 420, may include at least one of: (a) performing spell checking, (b) word or phrase correction, or (c) removing one or more words that are unrelated to the expected response. There are many types of spell checking techniques. A spell checker flags a word that does not match a pre-defined dictionary of properly spelled words and provides a properly spelled version of the word as a recommended word, if one is available. To determine whether the user provided a misspelled version of one of the answers, the virtual agent may perform a spell check to determine if any words, when spelled properly, cause the user response (or a portion of the user response) to match the answer (or a portion of the answer). For example, consider the answer “INSTAL OPRATING SYSTEM”. Further consider that the answer was provided in response to the question “WHAT MAY I HELP YOU WITH?”. The virtual agent, performing a normalized query match may spell check each of the words in the response and determine the response is supposed to be “INSTALL OPERATING SYSTEM”. If the spell checked and corrected version of the response, or a portion thereof, matches an answer expected by the virtual agent, or a portion thereof, the virtual agent may determine that the user wanted to select the answer that matches. The virtual agent may then select the answer for the user and proceed as defined by their dialog script.

Removing a portion of the user response may occur before or after the spell checking. In some embodiments, spell checking is only performed on a portion of the user response left after removing the portion of the user response. Removing a portion of the user response may include determining a part of speech for each word in the user response and removing one or more words that are determined to be a specified part of speech. For example, in the phrase “I AM USING OPERATING SYSTEM 9” the words “I am using” may not be an important part of the user response and may be removed, such that “OPERATING SYSTEM 9”, is the object of the sentence, and may be what the virtual agent compares to the answers.

In one or more embodiments, the user response, the answers provided by the virtual agent, or both may be converted to a regular expression. The regular expression may then be compared to the response, answer, or a regular expression thereof, to determine whether the response matches a provided answer. There are many techniques for generating and comparing regular expressions, such as may include deterministic and nondeterministic varieties of regular expression construction and comparison.

An ordinal match, as identified in operation 430, determines whether the response by the user corresponds to an index of an answer provided by the virtual agent. To determine whether the response includes an ordinal indicator (an indication of an index), the virtual agent may compare the response, or a portion thereof, (e.g., after spell checking, correction, or word removal) to a dictionary of ordinal indicators. Examples of ordinal indicators include “FIRST”, “SECOND”, “THIRD”, “FOURTH”, “ONE”, “TWO”, “THREE”, “FOUR”, “1”, “2”, “3”, “4”, “A”, “a”, “B”, “b”, “C”, “c”, “D”, “d”, “i”, “ii”, “iii”, roman numerals, or the like. The dictionary may include all possible, reasonable ordinal indicators. For example, if the virtual agent indicates options based on numbers, it may not be reasonable to include alphabetic characters in the dictionary of ordinal indicators, but not vice versa.

The virtual agent may determine whether the response includes an ordinal indicator in the dictionary. In response to determining that the response includes an ordinal indicator in the dictionary, the virtual agent may select the answer corresponding to the ordinal indicator.

With an inclusive match, as indicated in operation 440, the virtual agent may determine whether the user's response, or a portion thereof, matches a subset of only one provided answer. In response to determining the user's response matches a subset of only one provided answer, the virtual agent may select that answer for the user. The inclusive match may be performed using a string comparison on just a portion of the provided answer, just a portion of the response, or a combination thereof. For example, consider the question and provided answers: “WHICH PRODUCT IS GIVING YOU TROUBLE? A. OPERATING SYSTEM 8; B. OPERATING SYSTEM 9”. If the user responds “9”, then the virtual agent may select answer B, because “9” is a subset of only provided answer B.

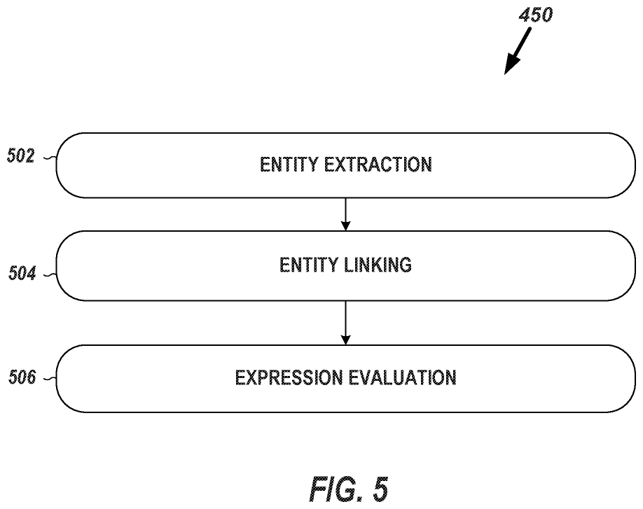

An entity match with reasoning, as identified at operation 450, determines whether an entity of a response matches an entity of a prompt and then employs logic to deduce which expected answer the response is intended to select. FIG. 5 illustrates, by way of example, a diagram of an embodiment of a method of performing the operation 450. The method 500 as illustrated includes entity extraction, at operation 502; entity linking, at operation 504; and expression evaluation, at operation 506. Operation 502 may include identifying entities in a user response. An entity may include a date, monetary value, year, age, person, product, family, or other thing. The entity may be identified using a regular expression or parts of speech analysis. A number, whether in a numerical symbol form (e.g., “1”, “2”, “3”, etc.) or in an alphabetic representation of the symbol (e.g., “one”, “two”, “three”, etc.) may be considered an entity, such as a monetary, age, year, or other entity.

At operation 504, the identified entity may be linked to an entity of the question. For example, consider the question: “WHAT IS YOUR AGE?”. The entity of interest is “AGE”. A number entity in the response to this question may thus be linked with the entity “AGE”.

At operation 506, the response may be evaluated to determine which provided answer, if any, the response corresponds. A different logic flow may be created for different entities. An embodiment of a logic flow for an “AGE” entity is provided as merely an example of a more complicated expression evaluation. Consider the question and provided answers: “WHAT IS YOUR AGE? A.) I AM YOUNGER THAN 20; B.) I AM 20-70 YEARS OLD; AND C.) I AM OLDER THAN 70 YEARS OLD.” Further consider the user's response “28”. Although the response “28” may match with many entities (e.g., day of the month, money, age, etc.) the context of the question provides a grounding to determine that “28” is an age. The virtual agent may then match the age “28” to answer B, as 28 is greater than, or equal to, 20 and less than 70, at the expression evaluation of operation 506.

Consider a different unstructured text user response to the same question: “I WAS BORN IN 1980”. The virtual agent may identify the entity “1980” in the response and based on the context identify that 1980 is a year. The virtual agent may then evaluate an age that corresponds to the given year (todays year minus the response year), and then evaluate the result in the similar manner as discussed previously. In this case, assume the year is 2018, the virtual agent may determine the age of the user is 38 and then evaluate 38 in the bounds of the provided answers to determine that the user should select answer B. The virtual agent may then select the answer B for the user and move on to the next question or provide resolution of the user's problem.

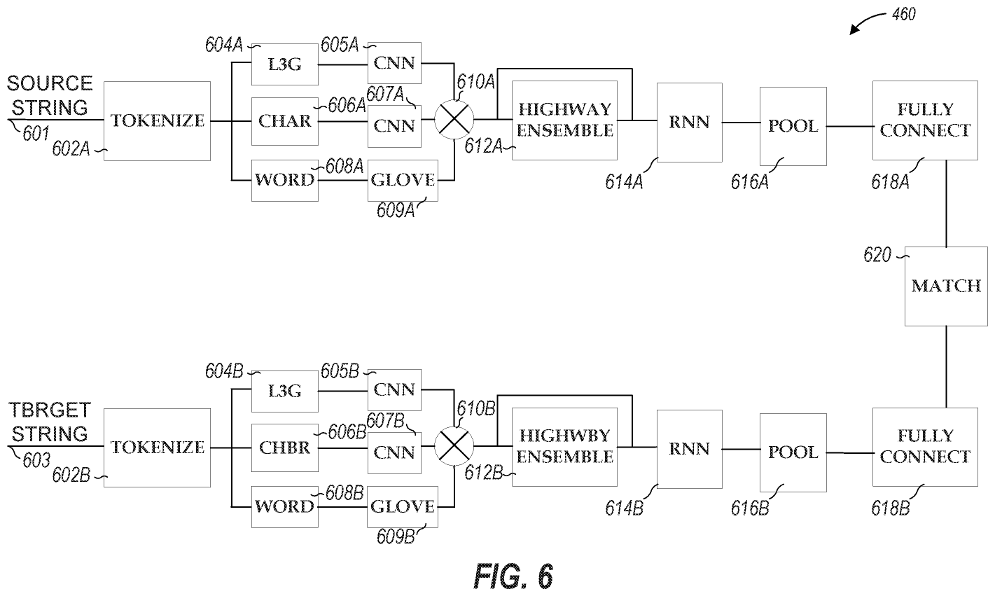

An example of a model configured to determine a semantic similarity (sometimes called a “model match”, and indicated at operation 460) is provided in FIG. 6. For semantic meaning matching, a model may be created that takes a user response (or a portion thereof) and a provided answer (or a portion thereof) as an input and provides a number indicating a semantic similarity between the response and the answer. A regular expression version, spell checked version, corrected version, or a combination thereof may be used in place of the response or the answer.

FIG. 6 illustrates, by way of example, a block flow diagram of an embodiment of the model match operation 460 for semantic matching. The operation 460 as illustrated includes parallel structures configured to perform same operations on different input strings, namely source string 601 and target string 603, respectively. One structure includes reference numbers with suffix “A” and another structure includes reference numbers with suffix “B”. For brevity, only one structure is described and it is to be understood that the other structure performs the same operations on a different string.

The source string 601 includes input from the user. The target string 603 includes a pre-defined intent, which can be defined at one of a variety of granularities. For example, an intent can be defined at a product level, version level, problem level, service level, or a combination thereof. The source string 601 or the target string 603 can include a word, phrase, sentence, character, a combination thereof or the like. The tokenizer 602A receives the source string 601, demarcates separate tokens (individual words, numbers, symbols, etc.) in the source string 601, and outputs the demarcated string.

The demarcated string can be provided to each of a plurality of post processing units for post processing operations. The post processing units as illustrated include a tri-letter gram 604A, a character processor 606A, and a word processor 608A. The tri-letter gram 604A breaks a word into smaller parts. The tri-letter gram 604A produces all consecutive three letter combinations in the received string. For example, a tri-letter gram output for the input of“windows” can include #wi, win, ind, ndo, dow, ows, ws#. The output of the tri-letter gram 604A is provided to a convolutional neural network 605A that outputs a vector of fixed length.

The character processor 606A produces a character embedding of the source string 601. The word processor 608A produces a word embedding of the source string 601. A character embedding and a word embedding are similar, but a character embedding n-gram can be shared across words. Thus, a character embedding can generate an embedding for an out-of-vocabulary word. A word embedding treats words atomically and does not share n-grams across words. For example, consider the phrase “game login”. The word embedding can include “#ga, gam, game, ame, me#” and “#lo, log, logi, login, ogi, ogin, gin, in#”. The character embedding can include an embedding for each character. In the phrase “game login”, the letter “g” has the same embedding across words. The embedding across words in a character embedding can help with embeddings for words that occur infrequently.

The character embedding from the character processor 606A can be provided to a CNN 607A. The CNN 607A can receive the character embedding and produce a vector of fixed length. The CNN 607A can be configured (e.g., with weights, layers, number of neurons in a layer, or the like) the same or different as the CNN 605A. The word embedding from the word processor 608A can be provided to a global vector processor 609A. The global vector processor 609A can implement an unsupervised learning operation to generate a vector representation for one or more words provided thereto. Training can be performed on aggregated global word-word co-occurrence statistics from a corpus.

The vectors from the CNN 605A, CNN 607A, and the global vector processor 609A can be combined by the vector processor 610A. The vector processor 610A can perform a dot product, multiplication, cross-correlation, average, or other operation to combine the vectors into a single, combined vector.

The combined vector can be provided to a highway ensemble processor 612A that allows for easier training of a DNN using stochastic gradient descent. There is plenty of theoretical and empirical evidence that depth of neural networks may be important for their success. However, network training becomes more difficult with increasing depth and training of networks with more depth remains an open problem. The highway ensemble processor 612A eases gradient-based training of deeper networks. The highway ensemble processor 612A allows information flow across several layers with lower impedance. The architecture is characterized by the use of gating units which learn to regulate the flow of information through a neural network. Highway networks with hundreds of layers can be trained directly using stochastic gradient descent and with a variety of activation functions, allowing for the possibility extremely deep and efficient architectures.

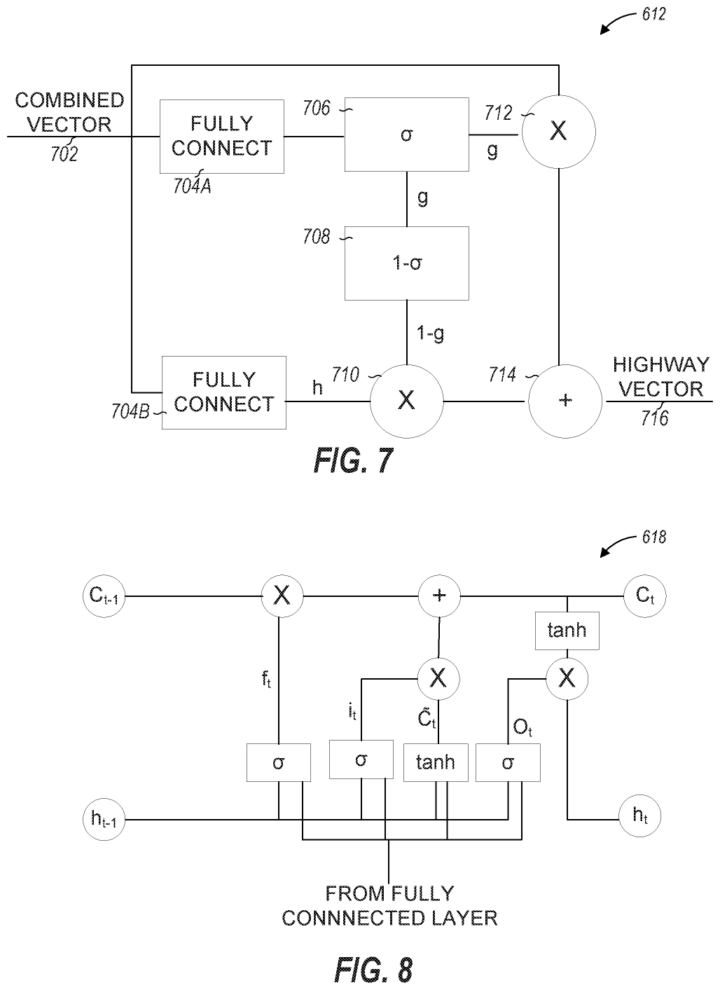

FIG. 7 illustrates, by way of example, a block flow diagram of an embodiment of the highway ensemble processor 612. A combined vector 702 can be received from the vector processor 610. The combined vector 702 can be input into two parallel fully connected layers 704A and 704B and provided to a multiplier 712. Neurons in a fully connected layer 704A-704B include connections to all activations in a previous layer. The fully connected layer 704B implements a transfer function, h, on the combined vector 702. The remaining operators, including a sigma processor 706, an inverse sigma operator 708, multiplier 710, multiplier 712, and adder 714 operate to produce a highway vector 716 in accord with the following Equations 1, 2, and 3:

g=σ(W_{g}·x+b_{g}) Equation 1

h=tan h(Wₕ·x+bₕ) Equation 2

y=h*(1−g)+x*g Equation 3

Where W_{g} and Wₕ are weight vectors, x is the input, y is the output, h is the transfer function, σ is a sigmoid function that maps an input argument to a value between [0, 1], and g is derived from σ.

The highway vector 716 from the highway ensemble processor 612A can be fedback as input to a next iteration of the operation of the highway ensemble processor 612A. The highway vector 716 can be provided to a recurrent neural network (RNN) 614A.

FIG. 8 illustrates, by way of example, a block flow diagram of an embodiment of the RNN 614. The blocks of the RNN 614 perform operations based on a previous transfer function, previous output, and a current input in accord with Equations 4, 5, 6, 7, 8, and 9:

fₜ=σ(W_{f}·[hₜ₋₁,xₜ]+b_{f}) Equation 4

iₜ=σ(Wᵢ·[hₜ₋₁,xₜ]+bᵢ) Equation 5

\tilde{C}ₜ=tan h(W_{C}[hₜ₋₁,xₜ]+b_{C}) Equation 6

Cₜ=fₜ*Cₜ₋₁+iₜ*\tilde{C}ₜ Equation 7

oₜ=σ(Wₒ·[hₜ₋₁,xₜ]+bₒ) Equation 8

hₜ=oₜ*tan h(Cₜ) Equation 9

The output of the RNN 614 may be provided to a pooling processor 616A. The pooling processor 612A combines outputs of a plurality of neurons from a previous layer into a single neuron. Max pooling, which uses a maximum value of all of the plurality of neurons, and average pooling, which uses an average value of all of the plurality of neurons, are examples of operations that may be performed by the pooling processor 616A. The pooled vector can be provided to a fully connected layer 618A, such as is similar to the fully connected layer 704A-704B. The output of the fully connected layer 618A can be provided to a match processor 620. The output of the fully connected layer 618A is a higher-dimensional vector (e.g., 64-dimensions, 128-dimensions, 256-dimensions, more dimensions, or some number of dimensions therebetween).

The space in which the output vector of the fully connected layer 618A resides is one in which items that are more semantic similar are closer to each other than items with less semantic similarity. Semantic similarity is different from syntactic similarity. Semantic similarity regards the meaning of a string, while syntactic similarity regards the content of the string. For example, consider the strings “Yew”, “Yep”, and “Yes”. “Yes”, “Yep”, and “Yew” are syntactically similar in that they only vary by a single letter. However, “Yes” and “Yep” are semantically very different from “Yew”. Thus, the higher-dimension vector representing “Yew” will be located further from the higher-dimension vector representing “Yes” than the higher-dimension vector representing “Yep”.

The match processor 620 receives the higher-dimension vectors from the fully connected layers 618A and 618B and produces a value indicating a distance between the vectors. The match processor 620 may produce a value indicating a cosine similarity or a dot product value between the vectors. In response to determining the score is greater than, or equal to, a specified threshold, the match processor 620 may provide a signal indicating the higher-dimensional vectors are semantically similar.

Operations 320 and 324 of FIG. 3 regard determining whether a conversation is in an offtrack state and how to handle a conversation in an offtrack state. As previously discussed, prior conversational virtual agents work well when a user follows virtual agent guidance in a strict way. However, when the user says something not pre-defined in system answers, most virtual agents fail to understand what the user means or wants. The virtual agent then does not know what the next step should be and makes the conversation hard to proceed. This not only reduces task success rate, but also results in a bad user experience. A response from the user that the virtual agent is not expecting may correspond to an answer provided by the virtual agent or a conversation being offtrack from the current conversation state. Embodiments of how to handle the former case are discussed with regard to FIGS. 3-6. The offtrack state case is discussed in more detail now.

If the user response is determined to not correspond to any of the provided answers, at operation 320 (see FIG. 3), the conversation may be deemed by the virtual agent to be in an offtrack state. Typical user response types (taxonomies) that indicate a conversation is in an offtrack state include intent change, rephrasing, complaining, appreciation, compliment, closing the conversation, and follow up questions. An intent of a user is the purpose for which the user accesses the virtual agent. An intent may include product help (e.g., troubleshooting problem X in product Y, version Z), website access help, billing help (payment, details, etc.), or the like. An intent may be defined on a product level, problem level, version level, or a combination thereof. For example, an intent may be, at a higher level, operating system help. In another example, the intent may be defined at lower level, such as logging in to a particular operating system version. An intent change may be caused by the virtual agent misinterpreting the user's intent or the user misstating their intent. For example, a user may indicate that they are using operating system version 6, when they are really using operating system version 9. The user may realize this error in the middle of the conversation with the virtual agent and point out the error in a response “SORRY, I MEANT OPERATING SYSTEM 9”. This corresponds to a change in intent.

Rephrasing, or repeating, may occur when the user types a response with a same or similar meaning as a previous response. In such cases, the user typically thinks that the virtual agent does not understand their response, and that stating the same thing another way will move the conversation forward.

Complaining may occur when that the user expresses frustration with some object or event, like the virtual agent, the product or service for which the user is contacting the virtual agent, or something else. Appreciation is generally the opposite of a complaint and expresses gratitude. Virtual agents may be helpful and some users like to thank the virtual agent.

Follow up questions may occur from users who need more information to answer the question posed by the virtual agent. For example, a user may ask “HOW DO I FIND THE VERSION OF THE OPERATING SYSTEM?” in response to “WHAT VERSION OF THE OPERATING SYSTEM ARE YOU USING?”. Follow up questions may be from the virtual agent to resolve an ambiguity.

Embodiments may detect whether the conversation is in an offtrack state. Embodiments may then determine, in response to a determination that the conversation is in an offtrack state, to which taxonomy of offtrack the conversation corresponds. Embodiments may then either jump to a new dialog script or bring the user back on track in the current dialog script based on the type of offtrack. How to proceed based on the type of offtrack may include rule-based or model-based reasoning.

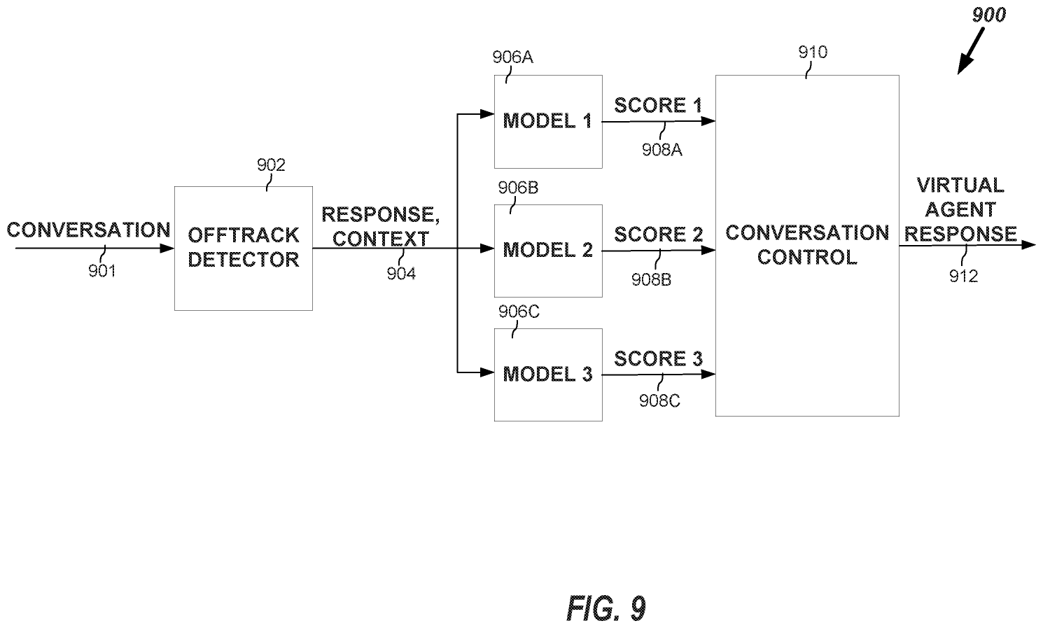

FIG. 9 illustrates, by way of example, a diagram of an embodiment of a system 900 for offtrack detection and response. The system 900 as illustrated includes an offtrack detector 902, one or more models 906A, 906B, and 906C, and a conversation controller 910. The offtrack detector 902 performs operation 320 of FIG. 3.

The offtrack detector 902 makes a determination of whether an unexpected response from the user corresponds to an answer. If the response does not correspond to an answer, the offtrack detector 902 indicates that the conversation is offtrack. The offtrack detector 902 may make the determination of whether the conversation is in an offtrack state based on a received conversation 901. The conversation 901 may include questions and provided answers from the virtual agent, responses from the user, or an indication of an order in which the questions, answers, and responses were provided. In some embodiments, the determination of whether the conversation is in an offtrack state may be based on only the most recent question, corresponding answers, and response from the user.

The offtrack detector 902 may provide the response from the user and the context of the response (a portion of the conversation that provides knowledge of what lead to the user response). The context may be used to help determine the type of offtrack. The response and context data provided by the offtrack detector is indicated by output 904. The context data may include a determined intent or that multiple possible intents have been detected, how many questions and responses have been provided in the conversation, a detected sentiment, such as positive, negative, or neutral, or the like.

The system 900 as illustrated includes three models 906A, 906B, and 906C. The number of models 906A-906C is not limiting and may be one or more. Each model 906A-906C may be designed and trained to detect a different type of offtrack conversation. The model 906A-906C may produce a score 908A, 908B, and 908C, respectively. The score 908A-908C indicates a likelihood that the offtrack type matches the type of offtrack to be detected by the model 906A-906C. For example, assume a model is configured to detect semantic similarity between a previous response and a current response. The score produced by that model indicates the likelihood that the conversation is offtrack with a repeat answer taxonomy. Generally, a higher score indicates that it is more likely offtrack in the manner to be detected by the model 906A-906C, but a lower score may indicate a better match in some embodiments.

The model 906A-906C may include a supervised or unsupervised machine learning model or other type of artificial intelligence model. The machine learning model may include a Recursive Neural Network (RNN), Convolutional Neural Network (CNN), a logistic regression model, or the like. A non-machine learning model may include a regular expression model.

An RNN is a kind of deep neural network (DNN). An RNN applies a same set of weights recursively over a structured input. The RNN produces a prediction over variable-size input structures. The RNN traverses a given structure, such as a text input, in topological order, (e.g., from a first character to a last character, or vice versa). Typically, stochastic gradient descent (SGD) is used to train an RNN. The gradient is computed using backpropagation through structure (BPTS). The RNN model to determine a semantic similarity between two strings may be used to determine whether a user is repeating a response. A different deep neural network (DNN) may be used to determine whether a user has changed intent.

A logistic regression model may determine a likelihood of an outcome based on a predictor variable. For example, in the context of embodiments, the predictor variable may include the conversation, or a portion thereof, between the virtual agent and the user. The logistic regression model generally iterates to find the 3 that best fits Equation 10:

$$y = \{ \begin{matrix}1 & for {β}_{0} + {β}_{1} x + error > 0 \\ 0 & else\end{matrix} \qquad Equation 10$$

In embodiments, a logistic regression model may determine whether a user response is one of a variety of off-track types including out-of-domain, a greeting, or is requesting to talk to an agent.

A regular expression model may determine whether a response corresponds a compliment, complaint, cuss word, conversation closing or the like. Regular expression models are discussed in more detail with regard to at least FIGS. 3-6.

The models 906A-906C may perform their operations in parallel (e.g., simultaneously, or substantially concurrently) and provide their corresponding resultant score 908A-908C to the conversation controller 910. The conversation controller 910 may, in some embodiments, determine whether the score is greater than, or equal to, a specified threshold. In such embodiments, it is possible that more than one of the scores 908A-908C is greater than, or equal to the threshold for a single response and context. In such conflicting instances, the conversation controller 910 may apply a rule to resolve the conflict. A rule may be, for example, choose the offtrack type corresponding to the higher score, choose the offtrack type that corresponds to the score that has the highest delta between the score 908A-908C and the specified threshold, choose the offtrack type corresponding to the model 906A-906C with a higher priority (e.g., based on conversation context and clarification engine status), or the like. The threshold may be different for each model. The threshold may be user-specified. For example, some models may produce lower overall scores than other models, such that a score of 0.50 is considered high, while for another model, that score is low.

The conversation controller 910 may determine, based on the offtrack type, what to do next in the conversation. Options for proceeding in the conversation may include, (a) expressing gratitude, (b) apologizing, (c) providing an alternative solution, (d) changing from a first dialog flow to a second, different dialog flow, (e) getting the user back on track in the current question flow using a repeat question, message, or the like.

As previously discussed, a classification model may be designed to identify responses of an offtrack taxonomy to be detected and responded to appropriately. Each model may consider user response text and/or context information. For example, assume the model 906A is to determine a likelihood that the user is repeating text. The score 908A produced by the model 906A may differ for a same user response when the conversation is at the beginning of a conversation or in the middle of a conversation (fewer or more questions and responses as indicated by the context information).

In one or more embodiments, the conversation controller 910 may operate based on pre-defined rules that are complimented with data-driven behaviors. The pre-defined rules may include embedded “if-then” sorts of statements that define which taxonomy of offtrack is to be selected based on the scores 908A-908C. The selected taxonomy may be associated with operations to be performed to augment an dialog script.

Some problems with using only if-then dialog scripts is that the users may provide more or less information than requested, the user may be sidetracked, the user may not understand a question, the user may not understand how to get the information needed to answer the question, among others. Augmenting the if-then statements with data-driven techniques for responding to a user, such as if the user provides a response that is not expected, may provide the flexibility to handle each of these problems. This provides an improved user experience and increases the usability of the virtual agent, thus reducing the amount of work to be done by a human analyst.

There are a variety of ways to proceed in a conversation in an offtrack state. FIG. 10 illustrates, by way of example, a diagram of an embodiment of a method for performing operation 324 of FIG. 3 (for handling an offtrack conversation). The operation 324 begins with detecting a conversation is offtrack, at operation 1002. A conversation may be determined to be offtrack in response to determining, at operation 320 (see FIG. 3), that the response from the user does not correspond to a provided answer. At operation 1004, a taxonomy of the offtrack conversation is identified. The taxonomies of offtrack conversations may include, for example, chit-chat, closing, user repeat, intent change, a predefined unexpected response, such as “ALL”, “NONE”, “DOES NOT KNOW”, “DOES NOT WORK”, or the like, a type that is not defined, or the like.

The taxonomy determination, at operation 1004, may be made by the conversation controller 910 based on the scores 908A-908C provided by the models 906A-906C, respectively. In response to determining the type of offtrack conversations, the conversation controller 910 may either check for an intent change, at operation 1016, or present fallback dialog, at operation 1010. In the embodiment illustrated, chit-chat, closing, or a pre-defined user response that is not expected 1008 may cause the conversation controller 910 to perform operation 1010. In the embodiment illustrated, other types of offtrack conversations, such as an undefined type, user repeat, or intent change type 1006 may cause the conversation controller 910 to perform operation 1016.

Different types of offtrack states may be defined and models may be built for each of these types of offtrack states, and different techniques may be employed in response to one or more of the types of offtrack conversations. The embodiments provided are merely for descriptive purposes and not intended to be limiting.

At operation 1010, the conversation controller 910 may determine whether there is a predefined fallback dialog for the type of offtrack conversation detected. In response to determining the fallback dialog is predefined, the conversation controller 910 may respond to the user using the predefined dialog script, at operation 1012. In response to determining there is no predefined fallback dialog for the type of offtrack conversations detected, the conversation controller 910 may respond to the user with a system message, at operation 1014. The system message may indicate that the virtual agent is going to start the process over, that the virtual agent is going to re-direct the user to another agent, or the like.

At operation 1016, the conversation controller 910 may determine if the user's intent has changed. This may be done by querying an intent ranker 1018 for the top-k intents 1020. The intent ranker 1018 may receive the conversation context as the conversation proceeds and produce a list of intents with corresponding scores. The intent of the user is discussed elsewhere herein, but generally indicates the user's reason for accessing the virtual agent. At operation 1022, the conversation controller 910 may determine whether any intents include a corresponding score greater than, or equal to, a pre-defined threshold. In response to determining there is an intent with a score greater than, or equal to, a pre-defined threshold the conversation controller 910 may execute the intent dialog for the intent with the highest score that has not been presented to the user this session. In response to determining there is no intent with a score greater than, or equal to, the pre-defined threshold, the conversation controller 910 may determine if there is a fallback dialog to execute, at operation 1038. The fallback dialog script, at operation 1038, may help the conversation controller 910 better define the problem to be solved, such as may be used to jump to a different dialog script.

If there is no dialog script, at operation 1034, the conversation controller 910 may determine if there are any instant answers available for the user's intent, at operation 1036. An instant answer is a solution to a problem. In some embodiments, a solution may be considered an instant answer only if there are less than a threshold number of solutions to the possible problem set, as filtered by the conversation thus far.

At operation 1040, the conversation controller 910 may determine if there are any instant answers to provide. In response to determining that there are instant answers to provide, the conversation controller 910 may cause the virtual agent to present one or more of the instant answers to the user. In response to determining that there are no instant answers to provide, the conversation controller 910 may initiate or request results of a web search, at operation 1044. The web search may be performed based on the entire conversation or a portion thereof. In one or more embodiments, keywords of the conversation may be extracted, such as words that match a specified part of speech, appear fewer or more times in the conversation, or the like. The extracted words may then be used for a web search, such as at operation 1046. The search service may be independent of the virtual agent or the virtual agent may initiate the web search itself.

At operation 1048, the conversation controller 910 may determine if there are any web results from the web search at operation 1044. In response to determining that there are web results, the conversation controller 910 may cause the virtual agent to provide the web results (e.g., a link to a web page regarding a possible solution to the problem, a document detailing a solution to the problem, a video detailing a solution to the problem, or the like) to the user, at operation 1050. In response to determining that there are no web results, the conversation controller 910 may determine if the number of conversation retries (failures and restarts) is less than a specified threshold, N, at operation 1052. In response to determining the number of retries is greater than the threshold, the conversation controller 910 may cause the virtual agent to restart the conversation with different phrasing or a different order of questioning. In response to determining the retry count is greater than, or equal to, the threshold, the conversation controller 910 may cause the virtual agent to indicate to the user that the virtual agent is not suited to solve the user's problem and provide an alternative avenue through which the user may find a solution to their problem.

The embodiment illustrated in FIG. 10 is very specific and not intended to be limiting. The order of operations, and responses to the operations in many cases, is subjective. This figure illustrates one way in which a response to a user may be data-driven (driven by actual conversation text and/or context), such as to augment a dialog script process.

Some data-driven responses, regarding some very common offtrack types are now discussed. For the “user repeat” taxonomy, the conversation controller 910 may choose the next best intent, excluding intents that were tried previously in the conversation, and follow the dialog script corresponding to that intent. The strategy for the “intent change” taxonomy may proceed in a similar manner. For the “out of domain” taxonomy, the conversation controller 910 may prevent the virtual agent from choosing an irrelevant intent, when the user asks a question outside of the virtual agent capabilities. The conversation controller 910 may cause the virtual agent to provide an appropriate response, such as “I AM NOT EQUIPPED TO ANSWER THAT QUESTION” or “THAT QUESTION IS OUTSIDE OF MY EXPERTISE”, transfer the conversation to a human agent, or to another virtual agent that is equipped to handle the question. For the complimentary, complaint, or chit-chat taxonomies, the virtual agent may reply with an appropriate message, such as “THANK YOU”, “I AM SORRY ABOUT YOUR FRUSTRATION, LETS TRY THIS AGAIN”, “I APPRECIATE THE CONVERSATION, BUT MAY WE PLEASE GET BACK ON TRACK”, or the like. The virtual agent may then repeat the last question. Note that much of the response behavior is customizable and may be product, client, or result dependent. In general, the offtrack state may be identified, the type of offtrack may be identified, and the virtual agent may react to the offtrack to allow the user to better navigate through the conversation. For example, as a reaction to a response of “DOES NOT WORK”, the conversation controller 910 may skip remaining questions and search for an alternative solution, such as by using the search service, checking for instant answers, or the like.

FIG. 11 illustrates, by way of example, a diagram of an embodiment of another embodiment of a method 1100 for offtrack conversation detection and response. The method 1100 can be performed by processing circuitry in hosting an interaction session through a virtual agent interface device. The method 1100 as illustrated includes receiving a prompt, expected responses to the prompt, and a response of the interaction session, the interaction session to solve a problem of a user, at operation 1110; determining whether the response indicates the interaction session is in an offtrack state based on the prompt, expected responses, and response, at operation 1120; in response to a determination that the interaction session is in the offtrack state, determining a taxonomy of the offtrack state, at operation 1130, and providing, based on the determined taxonomy, a next prompt to the interaction session, at operation 1140.

The method 1100 may further include implementing a plurality of models, wherein each of the models is configured to produce a score indicating a likelihood that a different taxonomy of the taxonomies applies to the prompt, expected responses, and response. The method 1100 may further include executing the models in parallel and comparing respective scores from each of the models to one or more specified thresholds and determine, in response to a determination that a score of the respective scores is greater than, or equal to the threshold, the taxonomy corresponding to the model that produced the score is the taxonomy of the offtrack state.

The method 1100 may further include, wherein the next prompt and next expected responses are the prompt and expected responses rephrased to bring the user back on track are the from a dialog script for a different problem. The method 1100 may further include, wherein the taxonomies include one or more of (a) chit-chat, (b) compliment, (c) complaint, (d) repeat previous response, (e) intent change, and (f) closing the interaction session. The method 1100 may further include receiving context data indicating a number of prompts and responses previously presented in the interaction session and the prompts and responses, and determining whether the interaction session is in an offtrack state further based on the context data.

The method 1100 may further include, wherein the models include a neural network configured to produce a score indicating a semantic similarity between a previous response and the response, the score indicating a likelihood that the response is a repeat of the previous response. The method 1100 may further include, wherein the models include a regular expression model to produce a score indicating a likelihood that the response corresponds to a compliment, a complaint, or a closing of the interaction session. The method 1100 may further include, wherein the models include a deep neural network model to produce a score indicating a likelihood that the intent of the user has changed.

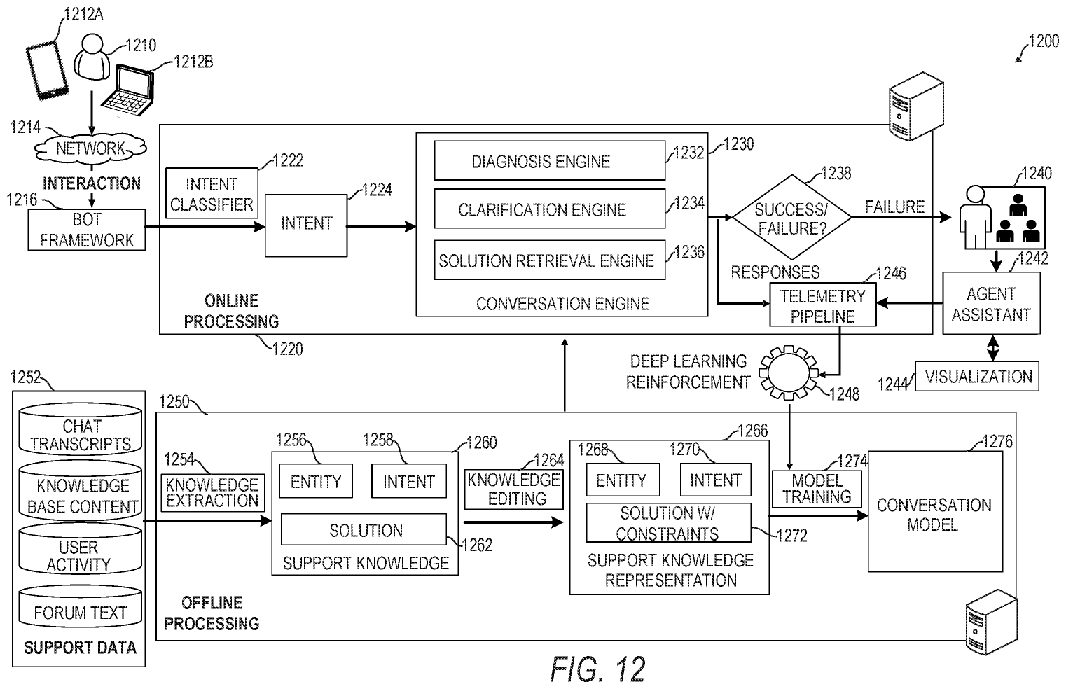

FIG. 12 illustrates, by way of example, a diagram of an embodiment of an example system architecture 1200 for enhanced conversation capabilities in a virtual agent. The present techniques for option selection may be employed at a number of different locations in the system architecture 1200, including a clarification engine 1234 of a conversation engine 1230.

The system architecture 1200 illustrates an example scenario in which a human user 1210 conducts an interaction with a virtual agent online processing system 1220. The human user 1210 may directly or indirectly conduct the interaction via an electronic input/output device, such as within an interface device provided by a personal computing device 1212. The human-to-agent interaction may take the form of one or more of text (e.g., a chat session), graphics (e.g., a video conference), or audio (e.g., a voice conversation). Other forms of electronic devices (e.g., smart speakers, wearables, etc.) may provide an interface for the human-to-agent interaction or related content. The interaction that is captured and output via the device 1212, may be communicated to a bot framework 1216 via a network. For instance, the bot framework 1216 may provide a standardized interface in which a conversation may be carried out between the virtual agent and the human user 1210 (such as in a textual chat bot interface).

The conversation input and output are provided to and from the virtual agent online processing system 1220, and conversation content is parsed and output with the system 1220 through the use of a conversation engine 1230. The conversation engine 1230 may include components that assist in identifying, extracting, outputting, and directing the human-agent conversation and related conversation content. As depicted, the conversation engine 1230 includes: a diagnosis engine 1232 used to assist with the output and selection of a diagnosis (e.g., a problem identification); a clarification engine 1234 used to obtain additional information from incomplete, ambiguous, or unclear user conversation inputs or to determine how to respond to a human user after receiving an unexpected response from the human user; and a solution retrieval engine 1236 used to select and output a particular solution or sets of solutions, as part of a technical support conversation. Thus, in the operation of a typical human-agent interaction via a chatbot, various human-agent text is exchanged between the bot framework 1216 and the conversation engine 1230.

The virtual agent online processing system 1220 involves the use of intent processing, as conversational input received via the bot framework 1216 is classified into an intent 1224 using an intent classifier 1222. As discussed herein, an intent refers to a specific type of issue, task, or problem to be resolved in a conversation, such as an intent to resolve an account sign-in problem, an intent to reset a password, an intent to cancel a subscription, an intent to solve a problem with a non-functional product, or the like. For instance, as part of the human-agent interaction in a chatbot, text captured by the bot framework 1216 is provided to the intent classifier 1222. The intent classifier 1222 identifies at least one intent 1224 to guide the conversation and the operations of the conversation engine 1230. The intent can be used to identify the dialog script that defines the conversation flow that attempts to address the identified intent. The conversation engine 1230 provides responses and other content according to a knowledge set used in a conversation model, such as a conversation model 1276 that can be developed using an offline processing technique discussed below.

The virtual agent online processing system 1220 may be integrated with feedback and assistance mechanisms, to address unexpected scenarios and to improve the function of the virtual agent for subsequent operations. For instance, if the conversation engine 1230 is not able to guide the human user 1210 to a particular solution, an evaluation 1238 may be performed to escalate the interaction session to a team of human agents 1240 who can provide human agent assistance 1242. The human agent assistance 1242 may be integrated with aspects of visualization 1244, such as to identify conversation workflow issues or understand how an intent is linked to a large or small number of proposed solutions. In other examples, such visualization may be used as part of offline processing and training.

The conversation model employed by the conversation engine 1230 may be developed through use of a virtual agent offline processing system 1250. The conversation model may include any number of questions, answers, or constraints, as part of generating conversation data. Specifically, FIG. 12 illustrates the generation of a conversation model 1276 as part of a support conversation knowledge scenario, where a human-virtual agent conversation is used for satisfying an intent with a customer support purpose. The purpose may include a technical issue assistance, requesting an action be performed, or other inquiry or command for assistance.

The virtual agent offline processing system 1250 may generate the conversation model 1276 from a variety of support data 1252, such as chat transcripts, knowledge base content, user activity, web page text (e.g., from web page forums), and other forms of unstructured content. This support data 1252 is provided to a knowledge extraction engine 1254, which produces a candidate support knowledge set 1260. The candidate support knowledge set 1260 links each candidate solution 1262 with an entity 1256 and an intent 1258. Although the present examples are provided with reference to support data in a customer service context, it will be understood that the conversation model 1276 may be produced from other types of input data and other types of data sources.

The candidate support knowledge set 1260 is further processed as part of a knowledge editing process 1264, which is used to produce a support knowledge representation data set 1266. The support knowledge representation data set 1266 also links each identified solution 1272 with an entity 1268 and an intent 1270, and defines the identified solution 1272 with constraints. For example, a human editor may define constraints such as conditions or requirements for the applicability of a particular intent or solution; such constraints may also be developed as part of automated, computer-assisted, or human-controlled techniques in the offline processing (such as with the model training 1274 or the knowledge editing process 1264).

Based on the candidate support knowledge set 1260, aspects of model training 1274 may be used to generate the resulting conversation model 1276. This conversation model 1276 may be deployed in the conversation engine 1230, for example, and used in the online processing system 1220. The various responses received in the conversation of the online processing may also be used as part of a telemetry pipeline 1246, which provides a deep learning reinforcement 1248 of the responses and response outcomes in the conversation model 1276. Accordingly, in addition to the offline training, the reinforcement 1248 may provide an online-responsive training mechanism for further updating and improvement of the conversation model 1276.

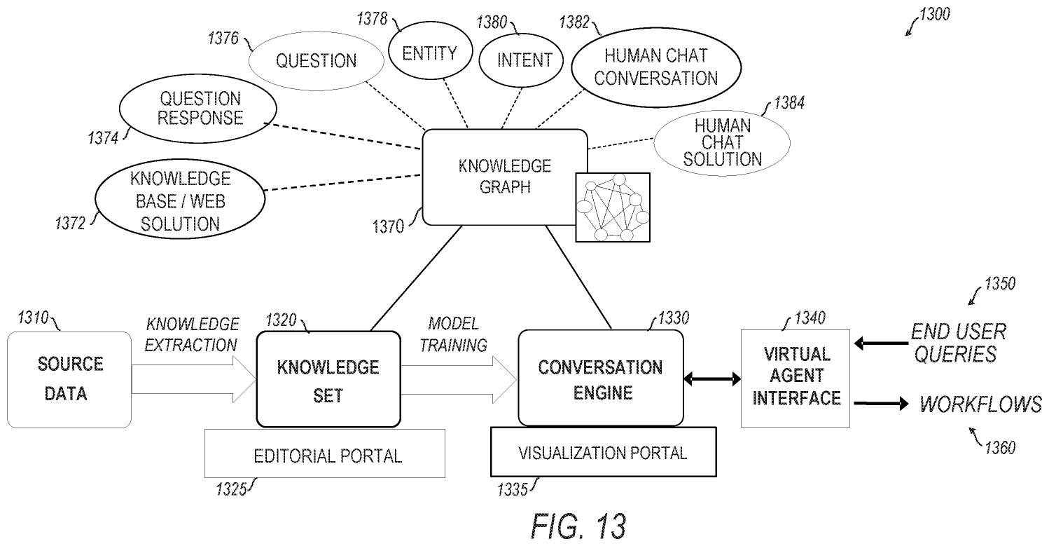

FIG. 13 illustrates, by way of example, a diagram of an embodiment of an operational flow diagram illustrating an example deployment 1300 of a knowledge set used in a virtual agent, such as with use of the conversation model 1276 and online/offline processing depicted in FIG. 12. The operational deployment 1300 depicts an operational sequence 1310, 1320, 1330, 1340, 1350, 1360 involving the creation and use of organized knowledge, and a data organization 1370, 1372, 1374, 1376, 1378, 1380, 1382, 1384, involving the creation of a data structure, termed as a knowledge graph 1370, which is used to organize concepts.

In an example, source data 1310 is unstructured data from a variety of sources (such as the previously described support data). A knowledge extraction process is operated on the source data 1310 to produce an organized knowledge set 1320. An editorial portal 1325 may be used to allow the editing, selection, activation, or removal of particular knowledge data items by an editor, administrator, or other personnel. The data in the knowledge set 1320 for a variety of associated issues or topics (sometimes called intents), such as support topics, is organized into a knowledge graph 1370 as discussed below.

The knowledge set 1320 is applied with model training, to enable a conversation engine 1330 to operate with the conversation model 1276 (see FIG. 12). The conversation engine 1330 selects appropriate inquiries, responses, and replies for the conversation with the human user, as the conversation engine 1330 uses information on various topics stored in the knowledge graph 1370. A visualization engine 1335 may be used to allow visualization of conversations, inputs, outcomes, intents, or other aspects of use of the conversation engine 1330.

The virtual agent interface 1340 is used to operate the conversation model in a human-agent input-output setting (sometimes called an interaction session). While the virtual agent interface 1340 may be designed to perform a number of interaction outputs beyond targeted conversation model questions, the virtual agent interface 1340 may specifically use the conversation engine 1330 to receive and respond to end user queries 1350 or statements from human users. The virtual agent interface 1340 then may dynamically enact or control workflows 1360 which are used to guide and control the conversation content and characteristics.

The knowledge graph 1370 is shown as including linking to a number of data properties and attributes, relating to applicable content used in the conversation model 1276. Such linking may involve relationships maintained among: knowledge content data 1372, such as embodied by data from a knowledge base or web solution source; question response data 1374, such as natural language responses to human questions; question data 1376, such as embodied by natural language inquiries to a human; entity data 1378, such as embodied by properties which tie specific actions or information to specific concepts in a conversation; intent data 1380, such as embodied by properties which indicate a particular problem or issue or subject of the conversation; human chat conversation data 1382, such as embodied by rules and properties which control how a conversation is performed; and human chat solution data 1384, such as embodied by rules and properties which control how a solution is offered and provided in a conversation.

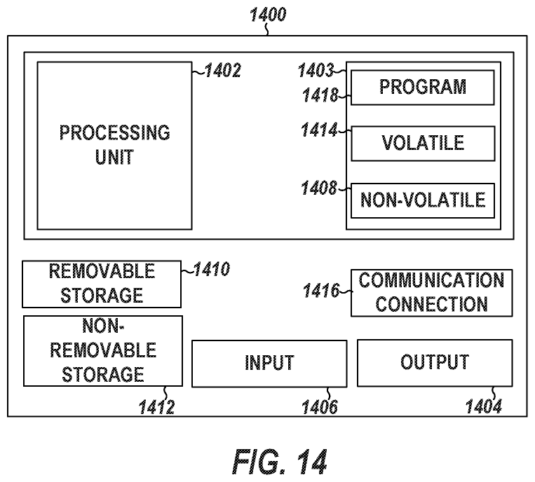

FIG. 14 illustrates, by way of example, a block diagram of an embodiment of a machine 1400 (e.g., a computer system) to implement one or more embodiments. One example machine 1400 (in the form of a computer), may include a processing unit 1402, memory 1403, removable storage 1410, and non-removable storage 1412. Although the example computing device is illustrated and described as machine 1400, the computing device may be in different forms in different embodiments. For example, the computing device may instead be a smartphone, a tablet, smartwatch, or other computing device including the same or similar elements as illustrated and described regarding FIG. 14. Devices such as smartphones, tablets, and smartwatches are generally collectively referred to as mobile devices. Further, although the various data storage elements are illustrated as part of the machine 1400, the storage may also or alternatively include cloud-based storage accessible via a network, such as the Internet.

Memory 1403 may include volatile memory 1414 and non-volatile memory 1408. The machine 1400 may include—or have access to a computing environment that includes—a variety of computer-readable media, such as volatile memory 1414 and non-volatile memory 1408, removable storage 1410 and non-removable storage 1412. Computer storage includes random access memory (RAM), read only memory (ROM), erasable programmable read-only memory (EPROM) & electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices capable of storing computer-readable instructions for execution to perform functions described herein.

The machine 1400 may include or have access to a computing environment that includes input 1406, output 1404, and a communication connection 1416. Output 1404 may include a display device, such as a touchscreen, that also may serve as an input device. The input 1406 may include one or more of a touchscreen, touchpad, mouse, keyboard, camera, one or more device-specific buttons, one or more sensors integrated within or coupled via wired or wireless data connections to the machine 1400, and other input devices. The computer may operate in a networked environment using a communication connection to connect to one or more remote computers, such as database servers, including cloud-based servers and storage. The remote computer may include a personal computer (PC), server, router, network PC, a peer device or other common network node, or the like. The communication connection may include a Local Area Network (LAN), a Wide Area Network (WAN), cellular, Institute of Electrical and Electronics Engineers (IEEE) 802.11 (Wi-Fi), Bluetooth, or other networks.

Computer-readable instructions stored on a computer-readable storage device are executable by the processing unit 1402 of the machine 1400. A hard drive, CD-ROM, and RAM are some examples of articles including a non-transitory computer-readable medium such as a storage device. For example, a computer program 1418 may be used to cause processing unit 1402 to perform one or more methods or algorithms described herein.

Additional examples of the presently described method, system, and device embodiments include the following, non-limiting configurations. Each of the following non-limiting examples may stand on its own, or may be combined in any permutation or combination with any one or more of the other examples provided below or throughout the present disclosure.

Example 1 includes a system comprising a virtual agent interface device to provide an interaction session in a user interface with a human user, processing circuitry in operation with the virtual agent interface device to receive, from the virtual agent interface device, a response regarding a problem, wherein the response is responsive to a prompt, and wherein the prompt is associated with one or more expected responses, determine whether the response is a match to one of the expected answers by performing one or more of (a) an ordinal match; (b) an inclusive match; (c) an entity match; and (d) a model match, and provide, responsive to a determination that the response is a match, a next prompt, or provide a solution to the problem, the next prompt associated with expected responses to the next prompt.

In Example 2, Example 1 may further include, wherein the determination of whether the response is a match further includes performing a normalized match that includes performing spell-checking and correcting of any error in the response and comparison of the spell-checked and corrected response to the expected responses.

In Example 3, Example 2 may further include, wherein the normalized match is further determined by removing one or more words from the response before comparison of the response to the expected responses.

In Example 4, at least one of Examples 1-3 may further include, wherein the determination of whether the response is a match includes performing the ordinal match and wherein the ordinal match includes evaluating whether the response indicates an index of an expected response of the expected responses to select.

In Example 5, at least one of Examples 1-4 may further include, wherein the determination of whether the response is a match includes performing the inclusive match and wherein the inclusive match includes determining, by evaluating whether the response includes a subset of only one of the expected responses.

In Example 6, at least one of Examples 1-5 may further include, wherein the expected responses include at least one numeric range, date range, or time range and wherein the determination of whether the response is a match includes performing the entity match with reasoning, wherein the entity match with reasoning includes determining, by evaluating whether the user response includes a numeral, date, or time that matches an entity of the prompt, and identifying to which numeric range, date range, or time range the numeral, date, or time corresponds.

In Example 7, at least one of Examples 1-6 may further include, wherein the determination of whether the response is a match includes performing the model match, and the model match includes determining by use of a deep neural network to compare the response, or a portion thereof, to each of the expected responses and provide a score for each of the expected responses that indicates a likelihood that the response semantically matches the expected response, and identifying a highest score that is higher than a specified threshold.

In Example 8, at least one of Examples 1-7 may further include, wherein the processing circuitry is further to determine whether the response is an exact match of any of the expected responses, and wherein the determination of whether the expected response is a match to one of the expected responses occurs in response to a determination that the response is not an exact match of any of the expected responses.

In Example 9, at least one of Examples 1-8 may further include, wherein the processing circuitry is configured to implement a matching pipeline that performs the determination of whether the response matches an expected response, the matching pipeline including a sequence of matching techniques including two or more of, in sequential order, (a) exact match, (b) normalized match, (c) ordinal match, (d) inclusive match, (e) entity match with reasoning, and (f) model match that operate in sequence and only if all techniques earlier in the sequence fail to find a match.

In Example 10, at least one of Examples 1-9 may further include, wherein the processing circuitry is configured to implement a matching pipeline that performs the determination of whether the response matches an expected response, the matching pipeline including a sequence of matching techniques including, in sequential order, (a) exact match, (b) normalized match, (c) ordinal match, (d) inclusive match, (e) entity match with reasoning, and (f) model match that operate in sequence and only if all techniques earlier in the sequence fail to find a match.

Example 11 includes a non-transitory machine-readable medium including instructions that, when executed by processing circuitry, configure the processing circuitry to perform operations of a virtual agent device, the operations comprising receiving, from a virtual agent interface device, a response regarding a problem, wherein the response is responsive to a prompt, and wherein the prompt is associated with one or more expected responses, determining whether the response is a match to one of the expected answers by performing one or more of (a) an ordinal match; (b) an inclusive match; (c) an entity match, and (d) a model match; and providing, responsive to a determination that the response is a match, a next prompt, or provide a solution to the problem, the next prompt associated with expected responses to the next prompt.

In Example 12, Example 11 further includes, wherein determining whether the response is a match further includes performing a normalized match that includes performing spell-checking and correcting of any error in the response and comparing the spell-checked and corrected response to the expected responses.

In Example 13, Example 12 further includes, wherein the normalized match is further determined by removing one or more words from the response before comparison of the response to the expected responses.

In Example 14, at least one of Examples 11-13 further includes, wherein determining whether the response is a match includes performing the ordinal match and wherein the ordinal match includes evaluating whether the response indicates an index of an expected response of the expected responses to select.

In Example 15, at least one of Examples 11-14 further includes, wherein determining whether the response is a match includes performing the inclusive match and wherein the inclusive match includes determining, by evaluating whether the response includes a subset of only one of the expected responses.

In Example 16, at least one of Examples 11-15 further includes, wherein the expected responses include at least one numeric range, date range, or time range and wherein the determination of whether the response is a match includes performing the entity match with reasoning, wherein the entity match with reasoning includes determining, by evaluating whether the user response includes a numeral, date, or time that matches an entity of the prompt, and identifying to which numeric range, date range, or time range the numeral, date, or time corresponds.

In Example 17, at least one of Examples 11-16 further includes, wherein determining whether the response is a match includes performing the model match, and the model match includes determining by use of a deep neural network to compare the response, or a portion thereof, to each of the expected responses and provide a score for each of the expected responses that indicates a likelihood that the response semantically matches the expected response, and identifying a highest score that is higher than a specified threshold.

In Example 18, at least one of Examples 11-17 further includes, determining whether the response is an exact match of any of the expected responses, and wherein the determination of whether the expected response is a match to one of the expected responses occurs in response to a determination that the response is not an exact match of any of the expected responses.

In Example 19, at least one of Examples 11-18 further includes implementing a matching pipeline that performs the determination of whether the response matches an expected response, the matching pipeline including a sequence of matching techniques including two or more of, in sequential order, (a) exact match, (b) normalized match, (c) ordinal match, (d) inclusive match, (e) entity match with reasoning, and (f) model match that operate in sequence and only if all techniques earlier in the sequence fail to find a match.

In Example 20, at least one of Examples 11-18 further includes implementing a matching pipeline that performs the determination of whether the response matches an expected response, the matching pipeline including a sequence of matching techniques including, in sequential order, (a) exact match, (b) normalized match, (c) ordinal match, (d) inclusive match, (e) entity match with reasoning, and (f) model match that operate in sequence and only if all techniques earlier in the sequence fail to find a match.

Example 21 includes a method comprising a plurality of operations executed with a processor and memory of a virtual agent device, the plurality of operations comprising receiving, from a virtual agent interface device of the virtual agent device, a response regarding a problem, wherein the response is responsive to a prompt, and wherein the prompt is associated with one or more expected responses, determining whether the response is a match to one of the expected answers by performing one or more of (a) an ordinal match; (b) an inclusive match; (c) an entity match; and (d) a model match, and providing, responsive to a determination that the response is a match, a next prompt, or provide a solution to the problem, the next prompt associated with expected responses to the next prompt.

In Example 22, Example 21 further includes, wherein the expected responses include at least one numeric range, date range, or time range and wherein the determination of whether the response is a match includes performing the entity match with reasoning, wherein the entity match with reasoning includes determining, by evaluating whether the user response includes a numeral, date, or time that matches an entity of the prompt, and identifying to which numeric range, date range, or time range the numeral, date, or time corresponds.

In Example 23, at least one of Examples 21-22 further includes, wherein determining whether the response is a match includes performing the model match, and the model match includes determining by use of a deep neural network to compare the response, or a portion thereof, to each of the expected responses and provide a score for each of the expected responses that indicates a likelihood that the response semantically matches the expected response, and identifying a highest score that is higher than a specified threshold.

In Example 24, at least one of Examples 21-23 further includes determining whether the response is an exact match of any of the expected responses, and wherein determining whether the expected response is a match to one of the expected responses occurs in response to a determination that the response is not an exact match of any of the expected responses.

In Example 25, at least one of Examples 21-24 further includes implementing a matching pipeline that determines whether the response matches an expected response, the matching pipeline including a sequence of matching techniques including two or more of, in sequential order, (a) exact match, (b) normalized match, (c) ordinal match, (d) inclusive match, (e) entity match with reasoning, and (f) model match that operate in sequence and only if all techniques earlier in the sequence fail to find a match.

In Example 26, at least one of Examples 21-25 further includes implementing a matching pipeline that performs the determination of whether the response matches an expected response, the matching pipeline including a sequence of matching techniques including, in sequential order, (a) exact match, (b) normalized match, (c) ordinal match, (d) inclusive match, (e) entity match with reasoning, and (f) model match that operate in sequence and only if all techniques earlier in the sequence fail to find a match.

In Example 27, at least one of Examples 21-26 further includes, wherein determining whether the response is a match further includes performing a normalized match that includes performing spell-checking and correcting of any error in the response and comparison of the spell-checked and corrected response to the expected responses.

In Example 28, Example 27 further includes, wherein the normalized match is further determined by removing one or more words from the response before comparison of the response to the expected responses.

In Example 29, at least one of Examples 21-28 further includes, wherein the determination of whether the response is a match includes performing the ordinal match and wherein the ordinal match includes evaluating whether the response indicates an index of an expected response of the expected responses to select.

In Example 30, at least one of Examples 21-29 further include, wherein determining whether the response is a match includes performing the inclusive match and wherein the inclusive match includes determining, by evaluating whether the response includes a subset of only one of the expected responses.

Example 31 includes a system comprising a virtual agent interface device to provide an interaction session in a user interface with a human user, the interaction session regarding a problem to be solved by a user, processing circuitry in operation with the virtual agent interface device to receive a prompt, expected responses to the prompt, and a response of the interaction session, determine whether the response indicates the interaction session is in an offtrack state based on the prompt, expected responses, and response, in response to a determination that the interaction session is in the offtrack state, determine a taxonomy of the offtrack state, and provide, based on the determined taxonomy, a next prompt to the interaction session.

In Example 32, Example 31 further includes, wherein the processing circuitry is configured to implement a plurality of models, wherein each of the models is configured to produce a score indicating a likelihood that a different taxonomy of the taxonomies applies to the prompt, expected responses, and response.

In Example 33, at least one of Examples 31-32 further include, wherein the processing circuitry is further to receive context data indicating a number of prompts and responses previously presented in the interaction session and the prompts and responses, and determine whether the interaction session is in an offtrack state further based on the context data.

In Example 34, at least one of Examples 32-33 further includes, wherein the models include a recurrent deep neural network configured to produce a score indicating a semantic similarity between a previous response and the response, the score indicating a likelihood that the response is a repeat of the previous response.

In Example 35, at least one of Examples 32-34 further includes, wherein the models include a regular expression model to produce a score indicating a likelihood that the response corresponds to a compliment, a complaint, or a closing of the interaction session.

In Example 36, at least one of Examples 32-35 further includes, wherein the models include a deep neural network model to produce a score indicating a likelihood that the intent of the user has changed.

In Example 37, at least one of Examples 32-36 further includes, wherein the processing circuitry is configured to execute the models in parallel and compare respective scores from each of the models to one or more specified thresholds and determine, in response to a determination that a score of the respective scores is greater than, or equal to the threshold, the taxonomy corresponding to the model that produced the score is the taxonomy of the offtrack state.

In Example 38, at least one of Examples 32-37 further includes, wherein the next prompt and next expected responses are the prompt and expected responses rephrased to bring the user back on track.

In Example 39, at least one of Examples 32-38 further includes, wherein the next prompt and next expected responses are the from a dialog script for a different problem.

In Example 40, at least one of Examples 31-39 further includes, wherein the taxonomies include one or more of (a) chit-chat, (b) compliment, (c) complaint, (d) repeat previous response, (e) intent change, and (f) closing the interaction session.

Example 41 includes a non-transitory machine-readable medium including instructions that, when executed by processing circuitry of a virtual agent device, configure the processing circuitry to perform operations comprising receiving, by a virtual agent interface device of the virtual agent device, a prompt, expected responses to the prompt, and a response of an interaction session regarding a problem to be solved by a user, determining whether the response indicates the interaction session is in an offtrack state based on the prompt, expected responses, and response, in response to determining that the interaction session is in the offtrack state, determine a taxonomy of the offtrack state, and providing, based on the determined taxonomy, a next prompt to the interaction session.

In Example 42, Example 41 further includes, wherein the operations further include implementing a plurality of models, wherein each of the models is configured to produce a score indicating a likelihood that a different taxonomy of the taxonomies applies to the prompt, expected responses, and response.

In Example 43, at least one of Examples 41-42 further includes, wherein the operations further include receiving context data indicating a number of prompts and responses previously presented in the interaction session and the prompts and responses, and determining whether the interaction session is in an offtrack state further based on the context data.

In Example 44, at least one of Examples 42-43 further includes, wherein the models include a recurrent deep neural network configured to produce a score indicating a semantic similarity between a previous response and the response, the score indicating a likelihood that the response is a repeat of the previous response.

In Example 45, at least one of Examples 42-44 further includes, wherein the models include a regular expression model to produce a score indicating a likelihood that the response corresponds to a compliment, a complaint, or a closing of the interaction session.

In Example 46, at least one of Examples 42-45 further includes, wherein the models include a deep neural network model to produce a score indicating a likelihood that the intent of the user has changed.

In Example 47, at least one of Examples 42-46 further includes, wherein the operations further include executing the models in parallel and compare respective scores from each of the models to one or more specified thresholds and determine, in response to determining that a score of the respective scores is greater than, or equal to the threshold, the taxonomy corresponding to the model that produced the score is the taxonomy of the offtrack state.

In Example 48, at least one of Examples 42-47 further includes, wherein the next prompt and next expected responses are the prompt and expected responses rephrased to bring the user back on track.

In Example 49, at least one of Examples 42-48 further includes, wherein the next prompt and next expected responses are the from a dialog script for a different problem.

In Example 50, at least one of Examples 41-49 further includes, wherein the taxonomies include one or more of (a) chit-chat, (b) compliment, (c) complaint, (d) repeat previous response, (e) intent change, and (f) closing the interaction session.

Example 51 includes a method performed by processing circuitry in hosting an interaction session through a virtual agent interface device, the method comprising receiving a prompt, expected responses to the prompt, and a response of the interaction session, the interaction session to solve a problem of a user, determining whether the response indicates the interaction session is in an offtrack state based on the prompt, expected responses, and response, in response to a determination that the interaction session is in the offtrack state, determining a taxonomy of the offtrack state, and providing, based on the determined taxonomy, a next prompt to the interaction session.

In Example 52, Example 51 further includes implementing a plurality of models, wherein each of the models is configured to produce a score indicating a likelihood that a different taxonomy of the taxonomies applies to the prompt, expected responses, and response.

In Example 53, Example 52 further includes executing the models in parallel and comparing respective scores from each of the models to one or more specified thresholds and determine, in response to a determination that a score of the respective scores is greater than, or equal to the threshold, the taxonomy corresponding to the model that produced the score is the taxonomy of the offtrack state.

In Example 54, at least one of Examples 52-53 further includes, wherein the next prompt and next expected responses are the prompt and expected responses rephrased to bring the user back on track are the from a dialog script for a different problem.

In Example 55, at least one of Examples 51-54 further includes, wherein the taxonomies include one or more of (a) chit-chat, (b) compliment, (c) complaint, (d) repeat previous response, (e) intent change, and (f) closing the interaction session.

In Example 56, at least one of Examples 51-55 further includes receiving context data indicating a number of prompts and responses previously presented in the interaction session and the prompts and responses, and determining whether the interaction session is in an offtrack state further based on the context data.

In Example 57, at least one of Examples 52-56 further includes, wherein the models include a neural network configured to produce a score indicating a semantic similarity between a previous response and the response, the score indicating a likelihood that the response is a repeat of the previous response.

In Example 58, at least one of Examples 52-57 further includes, wherein the models include a regular expression model to produce a score indicating a likelihood that the response corresponds to a compliment, a complaint, or a closing of the interaction session.

In Example 59, at least one of Examples 52-58 further includes, wherein the models include a deep neural network model to produce a score indicating a likelihood that the intent of the user has changed.

Although a few embodiments have been described in detail above, other modifications are possible. For example, the logic flows depicted in the figures do not require the order shown, or sequential order, to achieve desirable results. Other steps may be provided, or steps may be eliminated, from the described flows, and other components may be added to, or removed from, the described systems. Other embodiments may be within the scope of the following claims.

What is claimed is:

1. A system comprising:
a virtual agent interface device to provide an interaction session in a user interface with a human user, the interaction session regarding a problem to be solved by a user;
processing circuitry in operation with the virtual agent interface device to:
receive a prompt, expected responses to the prompt, and a response of the interaction session;
determine whether the response indicates the interaction session is in an offtrack state based on the prompt, expected responses, and response;
in response to a determination that the interaction session is in the offtrack state, determine a taxonomy of the offtrack state; and
provide, based on the determined taxonomy, a next prompt to the interaction session.

2. The system of claim 1, wherein the processing circuitry is configured to implement a plurality of models, wherein each of the models is configured to produce a score indicating a likelihood that a different taxonomy of the taxonomies applies to the prompt, expected responses, and response.

3. The system of claim 1, wherein the processing circuitry is further to receive context data indicating a number of prompts and responses previously presented in the interaction session and the prompts and responses, and determine whether the interaction session is in an offtrack state further based on the context data.

4. The system of claim 2, wherein the models include a recurrent deep neural network configured to produce a score indicating a semantic similarity between a previous response and the response, the score indicating a likelihood that the response is a repeat of the previous response.

5. The system of claim 2, wherein the models include a regular expression model to produce a score indicating a likelihood that the response corresponds to a compliment, a complaint, or a closing of the interaction session.

6. The system of claim 2, wherein the models include a deep neural network model to produce a score indicating a likelihood that the intent of the user has changed.

7. The system of claim 2, wherein the processing circuitry is configured to execute the models in parallel and compare respective scores from each of the models to one or more specified thresholds and determine, in response to a determination that a score of the respective scores is greater than, or equal to the threshold, the taxonomy corresponding to the model that produced the score is the taxonomy of the offtrack state.

8. The system of claim 2, wherein the next prompt and next expected responses are the prompt and expected responses rephrased to bring the user back on track.

9. The system of claim 2, wherein the next prompt and next expected responses are the from a dialog script for a different problem.

10. The system of claim 1, wherein the taxonomies include one or more of (a) chit-chat, (b) compliment, (c) complaint, (d) repeat previous response, (e) intent change, and (f) closing the interaction session.

11. A non-transitory machine-readable medium including instructions that, when executed by processing circuitry of a virtual agent device, configure the processing circuitry to perform operations comprising:
receiving, by a virtual agent interface device of the virtual agent device, a prompt, expected responses to the prompt, and a response of an interaction session regarding a problem to be solved by a user;
determining whether the response indicates the interaction session is in an offtrack state based on the prompt, expected responses, and response;
in response to determining that the interaction session is in the offtrack state, determine a taxonomy of the offtrack state; and
providing, based on the determined taxonomy, a next prompt to the interaction session.

12. The non-transitory machine-readable medium of claim 11, wherein the operations further include implementing a plurality of models, wherein each of the models is configured to produce a score indicating a likelihood that a different taxonomy of the taxonomies applies to the prompt, expected responses, and response.

13. The non-transitory machine-readable medium of claim 11, wherein the the operations further include receiving context data indicating a number of prompts and responses previously presented in the interaction session and the prompts and responses, and determining whether the interaction session is in an offtrack state further based on the context data.

14. The non-transitory machine-readable medium of claim 12, wherein the models include a recurrent deep neural network configured to produce a score indicating a semantic similarity between a previous response and the response, the score indicating a likelihood that the response is a repeat of the previous response.

15. The non-transitory machine-readable medium of claim 12, wherein the models include a regular expression model to produce a score indicating a likelihood that the response corresponds to a compliment, a complaint, or a closing of the interaction session.

16. A method performed by processing circuitry in hosting an interaction session through a virtual agent interface device, the method comprising:
receiving a prompt, expected responses to the prompt, and a response of the interaction session, the interaction session to solve a problem of a user;
determining whether the response indicates the interaction session is in an offtrack state based on the prompt, expected responses, and response;
in response to a determination that the interaction session is in the offtrack state, determining a taxonomy of the offtrack state; and
providing, based on the determined taxonomy, a next prompt to the interaction session.

17. The method of claim 16, further comprising implementing a plurality of models, wherein each of the models is configured to produce a score indicating a likelihood that a different taxonomy of the taxonomies applies to the prompt, expected responses, and response.

18. The method of claim 17, further comprising executing the models in parallel and comparing respective scores from each of the models to one or more specified thresholds and determine, in response to a determination that a score of the respective scores is greater than, or equal to the threshold, the taxonomy corresponding to the model that produced the score is the taxonomy of the offtrack state.

19. The method of claim 17, wherein the next prompt and next expected responses are the prompt and expected responses rephrased to bring the user back on track are the from a dialog script for a different problem.

20. The method of claim 16, wherein the taxonomies include one or more of (a) chit-chat, (b) compliment, (c) complaint, (d) repeat previous response, (e) intent change, and (f) closing the interaction session.
